(19) United States
(12) Patent Application Publication
(10) Pub. No.: US 2026/0200125 A1
(43) Pub. Date: Jul. 16, 2026

(54) Wood-Drilling Device, Wood-Drilling System, and Method for Producing a Wood-Drilling Device

(71) Applicant: Robert Bosch GmbH, Stuttgart (DE)

(72) Inventors: Martin Fischer, Luterbach (CH); Stefan Christen, Langendorf (CH); Lorenz Kaeser, Ruttenen (CH)

(21) Appl. No.: 19/564,659

(22) Filed: Mar. 12, 2026

Related U.S. Application Data
(63) Continuation of application No. 18/572,662, filed on Jun. 20, 2022.

(30) Foreign Application Priority Data
Jun. 30, 2021 (DE) 10 2021 206 797.2

(51) Int. Cl. B27G 15/00

(52) U.S. Cl. CPC B27G 15/00

(57) ABSTRACT

A wood-drilling device includes at least one drill shank, at least one drill tip, and at least one cutting body. The cutting body has at least one cutting wing, wherein at least one of the cutting wings has a cutting surface, which is arranged on a base side facing towards the drill tip. The cutting surface is formed by at least two mutually adjoining cutting partial surfaces which are angled away from a drill plane, oriented perpendicular to the rotation axis, in the direction of the drill shank and which are angled to each other at an angle and each have an angle to the rotation axis different from 0°.

This application is a continuation of U.S. application Ser. No. 18/572,662, filed on Dec. 20, 2023, which is a 35 U.S.C. § 371 National Stage Application of PCT/EP2022/066648, filed on Jun. 20, 2022, which claims the benefit of priority to Serial No. DE 10 2021 206 797.2, filed on Jun. 30, 2021 in Germany, the disclosures of all of which are incorporated herein by reference in their entirety.

### BACKGROUND

Various wood-drilling tools are already known from the prior art.

### SUMMARY

The disclosure starts with a wood-drilling device for drilling, in particular impact drilling, of a wood material, in particular containing metal fragments, with at least one drill shank, which is provided for clamping on a machine tool, with at least one drill tip, which preferably has a thread, and with at least one cutting body for cutting the wood material, wherein the cutting body has at least one, preferably at least two, cutting wings, that are in particular arranged symmetrically in relation to one another in relation to a rotation axis of the cutting body, wherein at least one of the cutting wings has a cutting surface which is arranged on a base side facing the drill tip, which base side is defined in particular in relation to an imaginary cylinder about the rotation axis.

It is proposed that the cutting surface is formed by at least two adjacent cutting partial surfaces which are angled from a drill plane aligned perpendicular to the rotation axis in the direction of the drill shank, which are angled at an angle in relation to one another, and which each have an angle other than 0° in relation to the rotation axis.

Preferably, the wood-drilling device comprises a drill tip, a cutting body and a drill shank, which together form a drilling unit. Preferably, the drilling unit is formed from a single, in particular at least partially metallic, preferably at least for the most part metallic, material composition, in particular from spring steel. Preferably, the drilling unit is formed in one piece. In particular, the drill tip and the cutting body are formed in one piece. In particular, the cutting body and the drill shank are formed in one piece. In particular, “in one piece” is to be understood as at least materially joined, for example by a welding process, an adhesive process, an injection molding process and/or any other process that appears reasonable to the person skilled in the art, and/or advantageously formed in one piece, such as by a production from casting and/or by production in a forging process or single- or multi-component injection molding process, and advantageously from a single blank. Preferably, the drill tip is connected to the cutting body at an end facing away from the drill shank. Preferably, the drill shank is connected to the cutting body at an end facing away from the drill tip. Preferably, the drilling unit is formed materially around the rotation axis. Preferably, the drilling unit is formed so that it is free of cavities inside the drilling unit. Particularly preferably, the drilling unit materially extends along the rotation axis, wherein a portion of the rotation axis extending between an end of the drill tip facing away from the drill shank and an end of the drill shank turned away from the drill tip through a material portion of the drilling unit. The drill shank at least partially has a different hardness from the drill tip, in particular as measured according to Rockwell.

Preferably, the drill tip comprises a thread. Preferably, the drill tip is formed materially symmetrically about the rotation axis apart from deviations of a maximum of 20%, preferably a maximum of 10%, in particular by volume. Preferably, the drill tip forms an end of the drilling unit that faces away from the drill shank.

Preferably, the drill shank has a shank body and a tool connecting body. Preferably, the tool connecting body is provided in portions for clamping on the machine tool. The term “provided” in particular is to be understood as specifically formed, programmed, designed, and/or equipped. The phrase “an object being provided for a specific function” in particular is to be understood is as meaning that the object fulfills and/or performs this specific function in at least one application and/or operating state. An operating state of the wood drilling device preferably is to be understood as a state in which the wood-drilling device is clamped to the machine tool and is preferably driven by the machine tool so that it rotates about the rotation axis.

Preferably, the shank body has a uniform, in particular constant, diameter. Preferably, the shank body has a uniformly sized, in particular constantly sized, cross-section perpendicular to the rotation axis, in particular independently of a measurement point along the rotation axis, in particular as measured on a surface of the cross-section. Preferably, the shank body has a uniformly shaped cross-section perpendicular to the rotation axis, in particular independently of a measurement point along the rotation axis, in particular as viewed on an outer contour of the cross-section. Preferably, the shank body is arranged between the cutting body and the tool connecting body. The shank body preferably has a cross-section that lies perpendicular to the rotation axis, with a circular outer contour.

Preferably, the tool connecting body comprises a transition region and a coupling region. Preferably, only the coupling region of the tool connecting body for clamping on the machine tool is provided. The coupling region is preferably designed as a hex region. Alternatively, the coupling region can be designed as a triplet, quat, hept, sept, oct region or the like, for example, wherein a triplet region describes a region, which is optionally partially formed in a cross-section perpendicular to the rotation axis by at least one rounded outer contour and which is partially formed by three, in particular ground, linear outer contours, and wherein higher numbered regions are defined analogously to the triplet region. Alternatively, the coupling region can have a substantially circular outer contour in a cross-section perpendicular to the rotation axis, which has partially flattened sections. Preferably, the coupling region, in particular the hex region, is designed, in particular formed, to be clamped on the machine tool. Preferably, the tool connecting body in the coupling region has a cross-section that lies perpendicular to the rotation axis with a hexagonal outer contour. Preferably, the transition region is arranged between the coupling region and the shank body. Preferably, the tool connecting body in the transition region as viewed along the rotation axis has various cross-sections perpendicular to the rotation axis, wherein the cross-sections have an outer contour, which forms a continuous transition between a hexagonal outer contour such as the tool connecting body and a circular outer contour such as the shank body. Preferably, the coupling region, in particular the hex region, forms an end of the drilling unit that faces away from the drill tip. The coupling region, in particular the hex region, can have a partial coupling region in which the coupling region, in particular the hex region, is designed to be tapered, preferably for snap-fit clamping on the machine tool. In particular, the coupling region, in particular the hex region, can have a cross-section perpendicular to the rotation axis in the partial coupling region, which has a non-uniformly shaped outer contour. In particular, the coupling region, in particular the hex region, can have a cross-section perpendicular to the rotation axis in the partial coupling region, which has an outer contour of hexagonal difference, in particular a circular outer contour. Preferably, the cutting body has a larger diameter at a boundary to the shank body, in particular a greater maximum extension perpendicular to the rotation axis, than the shank body.

Preferably, the cutting body has at least two cutting wings, preferably precisely two cutting wings, in particular arranged symmetrically in relation to one another in relation to a rotation axis of the cutting body. Preferably, the at least two cutting wings are symmetrically shaped. Preferably, a maximum radius, in particular a diameter, in particular a maximum extension of the cutting body perpendicular to the rotation axis, the drilling unit, in particular the wood-drilling device, is formed in relation to the rotation axis on the cutting wing. Preferably, the at least two cutting wings are arranged opposite each other in relation to the rotation axis. Preferably, a cutting wing is to be interpreted as a part of the cutting body that projects radially from the rotation axis, preferably opposite a central portion of the cutting body, wherein the cutting body is formed completely symmetrically around the rotation axis. The cutting body can have at least three, four, five or the like cutting wings that are symmetrically arranged in relation to one another relative to a rotation axis of the cutting body. Preferably, the cutting body as viewed along the rotation axis has non-uniform maximum transverse extensions, in particular non-uniform maximum diameters, perpendicular to the rotation axis. Preferably, the cutting body has a greater maximum radius, in particular diameter, in particular a greater maximum extension perpendicular to the rotation axis than the drill shank.

The cutting body preferably has a base side, in particular the front side. Preferably, the base side is defined in relation to a smallest imaginary cylinder, which has a cylinder axis, which is identical to the rotation axis, and which only just completely encloses the cutting body. Preferably, the base side consists of one side of the cutting body which faces the drill tip and which, in particular, faces a base side of the smallest imaginary cylinder. Preferably, the base side of the cutting body defines the imaginary drill plane as a plane, which is directly adjacent to the base side of the cutting body, and is aligned perpendicular to the rotation axis. Preferably, the drill plane is an imaginary plane, which is oriented perpendicular to the rotation axis, and which is arranged at the end of the cutting body that faces the drill tip between the drill tip and the cutting body. Preferably, the drill plane is arranged directly adjacently to the cutting body. Preferably, the imaginary drill plane is arranged directly adjacently to the cutting body.

Preferably, the at least one, preferably at least two, cutting wings, preferably in each case, have a cutting surface, which is arranged on the base side of the cutting body that faces the drill tip. Preferably, a smallest distance of the cutting surfaces to the rotation axis is at least a maximum thickness, preferably at least 120% of the maximum thickness, of the drill tip, in particular as measured perpendicular to the rotation axis. Preferably, the cutting surfaces can be directly adjacent to the drill tip, however it would also be conceivable for the cutting surfaces to be at least partially spaced from the drill tip, for example for production reasons. Preferably, the at least two cutting surfaces are arranged symmetrically in relation to each other about the rotation axis. Preferably, the cutting surface, in particular an edge of the cutting surface, is at least partially designed to remove, cut, and/or wear away the wood material and/or metal fragments in the wood material, in particular in the operating state of the wood-drilling device. Preferably, the at least one, preferably each, cutting surface is formed by at least two, in particular precisely two, directly adjacent cutting surfaces, in particular forming a common boundary edge towards each other. Preferably, the at least one, preferably each, cutting surface is formed by at least two, in particular precisely two, in particular along an increasing diameter, cutting partial surfaces that are angled from the drill plane towards the drill shank and are adjacent to one another. Preferably, the at least two cutting partial surfaces of each cutting surface are angled towards each other at an angle of at least 10°, preferably at least 20°, more preferably at least 30°, and more preferably at least 40°. Preferably, the at least two cutting partial surfaces of each cutting surface are angled towards each other at an angle of no more than 80°, preferably no more than 70°, more preferably no more than 60°, and most preferably no more than 50°. Preferably, the at least two cutting partial surfaces of each cutting surface are arranged adjacently one another without an offset, in particular along the rotation axis. Preferably, the at least two cutting partial surfaces of each cutting surface in each case have an angle of 0°, 90°, or 180° in relation to the rotation axis. Preferably, the cutting partial surfaces in each case form obtuse angles in relation to the rotation axis. Preferably, the cutting partial surfaces of a cutting surface in each case form blunt inner angles and/or outer angles towards each other. Preferably, a cutting partial surface of the at least two cutting partial surfaces of each cutting surface that faces the drill tip is less angled from the drill shank towards the drill tip towards a radial direction than a cutting partial surface of the at least two cutting partial surfaces of each cutting surface that faces away from the drill tip. Preferably, the cutting partial surface of the at least two cutting partial surfaces of each cutting surface that faces away from the drill tip is angled more closely from the drill shank along a radial direction than the cutting partial surface of the at least two cutting partial surfaces of each cutting surface facing the drill tip. Preferably, the cutting partial surface of the at least two cutting partial surfaces of each cutting surface that faces away from the drill tip is adjacent to a terminal point of a maximum extension of the cutting body perpendicular to the rotation axis. Preferably, the cutting partial surface of the at least two cutting partial surfaces of each cutting surface that faces away from the drill tip is angled circumferentially opposite the cutting partial surface of the at least two cutting partial surfaces of each cutting surface, in particular opposite a direction of rotation.

Due to the design of the wood-drilling device according to the disclosure, an advantageously robust wood-drilling device can be achieved, which is, in particular, suitable for cutting a plurality of metal fragments when drilling the wood material. In particular, an advantageous gradual chipping of the wood material and/or metal fragments can be achieved. An advantageously durable wood-drilling device can thereby be achieved. Advantageous drilling of wood materials can in particular be achieved, in particular without regard to nail residues or other metal fragments that could be contained in the wood material. Advantageously fast drilling operations can be achieved. In particular, risks to stress singularities at a radial outer edge of the cutting surfaces can be advantageously reduced, thereby reducing wear in particular. An advantageously low drilling resistance can thereby be achieved.

Furthermore, it is proposed that the at least two cutting partial surfaces are formed as flat surfaces. Preferably, the at least two cutting partial surfaces of each cutting surface in each case are designed as flat surfaces, wherein in particular, each point of the surface of one of the at least two cutting partial surfaces is arranged in a two-dimensional plane within production tolerances. Preferably, the at least two cutting partial surfaces are angled along a direction perpendicular to a greatest extension of the cutting body, perpendicular to the rotation axis from the drill plane towards the drill shank. Preferably, the at least two cutting partial surfaces are angled along a direction perpendicular to a greatest extension of the cutting body, perpendicular to the rotation axis from the drill plane towards the drill shank at an angle of at least 2°, preferably at least 5°, in particular within tolerances of a maximum of 1°. Preferably, the at least two cutting partial surfaces are angled along a direction perpendicular to a greatest extension of the cutting body, perpendicular to the rotation axis from the drill plane towards the drill shank at a same angle, in particular up to tolerances of a maximum of 1°. An advantageously robust contact surface of the cutting body with the wood material and/or the metal fragments can be achieved.

It is further proposed that a cutting partial surface of the at least two cutting partial surfaces that faces the drill tip has a 5° angle to the drill plane, up to deviations of a maximum of 2°. Preferably, the at least two cutting partial surfaces of each cutting surface, in particular along an increasing diameter, preferably along the increasing greatest extent of the cutting body perpendicular to the rotation axis, are angled from the drill plane towards the drill shank at least at an angle of at least 2.5°, preferably at least 5°, in particular with a tolerance of 2°. Preferably, at least one of the at least two cutting partial surfaces, in particular, the cutting partial surface of the at least two cutting partial surfaces of each cutting surface facing the drill tip, in particular along an increasing diameter, preferably along the increasing greatest extent of the cutting body perpendicular to the rotation axis, is angled from the drill plane towards the drill shank at least at an angle of at least 2,5°, preferably at least 5°, angled, in particular with a tolerance of a maximum of 2°. An advantageously sharply defined contact edge, in particular to contact the wood material and/or the metal fragments, of the cutting partial surface of the at least two cutting partial surfaces facing the drill tip can be achieved.

Furthermore, it is proposed that a cutting partial surface of the at least two cutting partial surfaces that faces away from the drill tip has a 45° angle to the drill plane up to deviations of a maximum of 5°. Preferably, at least one of the at least two cutting partial surfaces of each cutting surface along an increasing diameter, preferably along the increasing greatest extent of the cutting body perpendicular to the rotation axis, is angled from the drill plane towards the drill shank at least at an angle of at least 30°, preferably at least 35°, more preferably at least 40°, and more preferably at least 45°, in particular with a tolerance of a maximum of 3°. Preferably, the cutting partial surface of the at least two cutting partial surfaces of each cutting surface, in particular along an increasing diameter, preferably along the increasing greatest extent of the cutting body perpendicular to the rotation axis, is angled from the drill plane towards the drill shank at a 45°angle, in particular with a tolerance of a maximum of 5°, preferably with a tolerance of a maximum of 3°. An advantageously stable edge region of the cutting body that faces the wood material can be achieved.

It is furthermore proposed that a cutting partial surface of the at least two cutting partial surfaces that faces the drill tip has a maximum extension perpendicular to the rotation axis, which extends to a maximum of twice as far as a maximum extension perpendicular to the rotation axis of a cutting partial surface of the at least two cutting partial surfaces that faces away from the drill tip. Preferably, the cutting partial surface of the at least two cutting partial surfaces of one of the cutting surfaces facing the drill tip has a maximum extension perpendicular to the rotation axis, which extends at least a third, preferably at least half, particularly preferably at least two thirds, and more particularly preferably at least precisely, as far as a maximum extent perpendicular to the rotation axis of the cutting partial surface of the at least two cutting partial surfaces of one of the cutting surfaces that faces away from the drill tip. Preferably, the cutting partial surface of the at least two cutting partial surfaces of one of the cutting surfaces facing the drill tip has a maximum extent perpendicular to the rotation axis, which extends exactly twice as far as a maximum extent perpendicular to the rotation axis of the cutting partial surface of the at least two cutting partial surfaces of one of the cutting surfaces that faces away from the drill tip. Advantageously large and advantageously robust cutting surfaces of the cutting body can be achieved.

Furthermore, it is proposed that a cutting partial surface of the at least two cutting partial surfaces facing the drill tip has a maximum extension perpendicular to the rotation axis extending at least equal to a maximum extension perpendicular to the rotation axis of a cutting partial surface of the at least two cutting partial surfaces that faces away from the drill tip. Preferably, each of the cutting surfaces has a cutting partial surface arranged, in particular radially on the inner side, and a cutting partial surface arranged, in particular radially on the outer side, facing away from the drill tip. Preferably, the cutting partial surface of a cutting surface that faces the drill tip has a maximum extension perpendicular to the rotation axis, which extends at least one and a half times, preferably at least 1.75 times, more preferably at least 1.8 times, and more preferably at least 1.9 times, as far as a maximum extension perpendicular to the rotation axis of the cutting partial surface of the cutting surface, in particular the same cutting surface that faces away from the drill tip. Advantageously large and advantageously robust cutting surfaces of the cutting body can be achieved.

It is also proposed that at least one of the cutting wings has at least two radial outer surfaces that are angled towards each other along a radial edge, which extends parallel to the rotation axis up to deviations of no more than 15°, which are arranged at a free end of the respective cutting wing radially facing away from the rotation axis, and at a maximum distance from the rotation axis. Preferably, the radial edge extends to deviations of a maximum of 10°, preferably of a maximum of 5°, parallel to the rotation axis. Preferably, the radial edge is arranged on an outer surface of the cutting body maximally spaced from the rotation axis, in particular perpendicular to the rotation axis. Preferably, the radial outer surfaces are arranged on a sheath side of the cutting body, wherein the sheath side of the cutting body is defined, in particular analogously to a sheath side of the smallest imaginary cylinder, which has a cylinder axis, which is identical to the rotation axis and which only just completely encloses the cutting body. Preferably, the radial edge is arranged on the sheath side of the cutting body. Preferably, the radial edge is an outer edge of the cutting body, which separates from one another the two outer surfaces that are on average farthest away from the rotation axis, in particular from all outer surfaces of the cutting body. Preferably, the radial outer surfaces are the outer surfaces of the cutting body which, on average, are arranged farthest away from the rotation axis, in particular of all outer surfaces of the cutting body. Preferably, the cutting body has at least two, preferably precisely two, radial outer surfaces angled towards one another on each cutting wing, which are in particular separated from one another in each case by a radial edge, which in particular extends to deviations of a maximum of 15° parallel to the rotation axis. Preferably, the in each case at least two radial outer surfaces on each cutting wing in each case are concavely angled towards each other as viewed from the rotation axis. Preferably, the at least two, preferably precisely two, radial outer surfaces are angled towards each other at an angle of at least 5°, preferably at least 10°, more preferably at least 15°, and more preferably at least 19°, in particular with a tolerance of a maximum of 6°. Preferably, an outer edge differing from the radial edge, in particular a radial outer edge, of the at least two, preferably precisely two, radial outer surfaces at least partially defines the greatest extension of the cutting body perpendicular to the rotation axis. Preferably, two outer edges perpendicular to the rotation axis and opposite to each other that differ from radial edges, in particular radial outer edges, of the at least two, preferably exactly two, radial outer surfaces of two cutting wings at least partially define the greatest extension of the cutting body perpendicular to the rotation axis. Preferably, the radial outer surfaces are arranged on a radial outer side of the cutting body. Preferably, a radial outer side has one side of the cutting body, which is arranged farthest in the radial direction, in particular from all sides of the cutting body, away from the rotation axis. Preferably, the cutting body has two radial outer sides, which are, on average, equidistant from the rotation axis. An advantageously robust radial outer side of the cutting body can be achieved, which can be advantageously cost-effectively formed.

Moreover, a wood-drilling system with an electric machine tool and with at least one wood-drilling device according to the present disclosure is proposed. The machine tool is preferably designed for holding a wood-drilling device according to the disclosure. Preferably, the tool machine has a tool receptacle for holding, preferably clamping, a wood-drilling device according to the present disclosure. Preferably, the electric machine tool is designed as an electric drilling machine. Advantageous compatibility of the tool holder of the machine tool with the wood-drilling device, in particular the drill shank of the wood-drilling device, can be achieved.

Furthermore, a method for producing a wood drilling device according to the disclosure is proposed. In particular, the method for producing a wood-drilling device according to the disclosure is at least partially designed as a forging method. An advantageously high-quality wood-drilling device can thereby be achieved.

Furthermore, it is proposed that in at least one method step, the drilling unit is forged from a drill head blank, wherein a maximum diameter of the cutting body, in particular as measured perpendicularly to a longitudinal axis of the drill shank, is at least one and a half times as large as an original diameter of the drill head blank, in particular perpendicular to a longitudinal axis of the drill head blank, in particular prior to the forging process. In particular, an original diameter denotes a uniform diameter of a drill head blank prior to a forging process. Preferably, in at least one method step, the drilling unit is forged with a maximum extension perpendicular to the rotation axis from the drill head blank, wherein the original diameter of the drill head blank is measured to be, in particular perpendicular to a longitudinal axis of the drill head blank, in particular prior to the forging process, a maximum of two thirds times as large as the maximum extension of the drilling unit perpendicular to the rotation axis and/or the longitudinal axis of the drilling unit. A “longitudinal axis” of an object is to be understood in particular to signify an axis which runs parallel to a longest edge of a smallest geometric cuboid which only just completely encloses the object, and preferably runs through a geometric center of the object. Alternatively, in at least one method step, the drill shank, the sheath body and the drill tip can be sintered, additively produced, and/or powdered metal injection molded from a drill head blank. Advantageously low-cost production of the wood-drilling device can be achieved.

The wood drilling device according to the disclosure, the wood drilling system according to the disclosure and/or the method according to the disclosure are not to be limited hereby to the application and embodiment described above. In particular, the wood drilling apparatus according to the disclosure, the wood drilling system according to the disclosure, and/or the method according to the disclosure can have a number deviating from a number of individual elements, components, units and process steps described herein in order to fulfill a mode of operation described herein. Moreover, for the ranges of values indicated in this disclosure, values lying within the aforementioned limits are also intended to be considered to be disclosed and usable as desired.

### BRIEF DESCRIPTION OF THE DRAWINGS

Further advantages follow from the description of the drawings hereinafter. The drawing shows an embodiment example of the disclosure. The drawing, the description, and the claims contain numerous features in combination. A skilled person will appropriately also consider the features individually and combine them into additional advantageous combinations.

The following are shown:

FIG. 1 a wood-drilling system according to the disclosure with two wood-drilling devices according to the disclosure and a machine tool in a schematic representation,

FIG. 2 the wood-drilling device according to the disclosure in a schematic diagram,

FIG. 3 the wood-drilling device according to the disclosure in a schematic diagram,

FIG. 4 the wood-drilling device according to the disclosure in a schematic diagram,

FIG. 5 the wood-drilling device according to the disclosure in a schematic diagram,

FIG. 6 the wood-drilling device according to the disclosure in a schematic diagram,

FIG. 7 the wood-drilling device according to the disclosure in a schematic diagram,

FIG. 8 the wood-drilling device according to the disclosure in a schematic diagram,

FIG. 9 the wood-drilling device according to the disclosure in a schematic diagram,

FIG. 10 the wood-drilling device according to the disclosure in a schematic cross-section,

FIG. 11 the wood-drilling device according to the disclosure in a schematic cross-section,

FIG. 12 the wood-drilling device according to the disclosure in a schematic cross-section,

FIG. 13 the wood-drilling device according to the disclosure in a schematic cross-section,

FIG. 14 the wood-drilling device according to the disclosure in a schematic cross-section,

FIG. 15 the wood-drilling device according to the disclosure in a schematic cross-section,

FIG. 16 the wood-drilling device according to the disclosure in a schematic cross-section,

FIG. 17 the wood-drilling device according to the disclosure in a schematic cross-section,

FIG. 18 a method according to the disclosure in a schematic diagram,

FIG. 19 an alternative wood-drilling device according to the disclosure in a schematic diagram, and

FIG. 20 the alternative wood-drilling device according to the disclosure in a schematic diagram.

### DETAILED DESCRIPTION

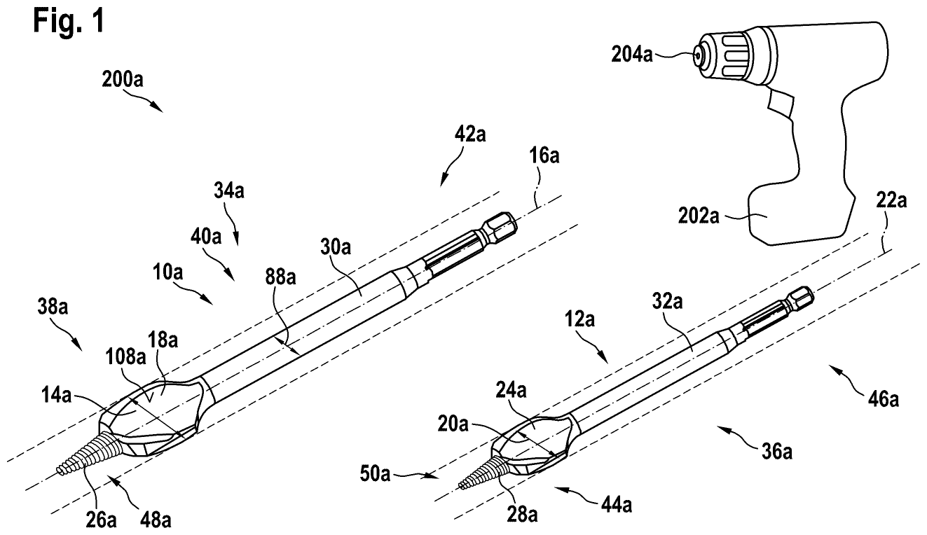

FIG. 1 shows a wood-drilling system 200a. The wood-drilling system 200a comprises two different wood-drilling devices 10a, 12a. The wood-drilling system 200a comprises an electric machine tool 202a for holding in each case one, for example, of the two wood-drilling devices 10a, 12a. The machine tool 202a has a tool receptacle 204a for a receptacle, for example a clamping device, of a wood-drilling device 10a, 12a. The electric machine tool 202a is designed as an electric drilling machine and/or as a cordless screwdriver or the like.

A first wood-drilling device 10a of the two wood-drilling devices 10a, 12a has a maximum diameter 14a perpendicular to a rotation axis 16a of more than 22.5 mm. In particular, the first wood-drilling device 10a has a discrete maximum diameter 14a of 25.8 mm, 28.6 mm or 32.1 mm, in particular with a tolerance of a maximum of 0.3 mm. The first wood-drilling device 10a of the two wood-drilling devices 10a, 12a has a cutting body 18a with a maximum diameter 14a perpendicular to the rotation axis 16a of more than 22.5 mm. In particular, the cutting body 18a of the first wood-drilling device 10a has the discrete maximum diameter 14a of 25.8 mm, 28.6 mm, or 32.1 mm, in particular with a tolerance of a maximum of 0.3 mm.

A second wood-drilling device 12a of the at least two wood-drilling devices 10a, 12a has a maximum diameter 20a perpendicular to a rotation axis 22a of a maximum of 22.5 mm. In particular, the second wood-drilling device 12a has a discrete maximum diameter 20a of 13.0 mm, 16.2 mm, 19, 4 or 22.5 mm, in particular with a tolerance of a maximum of 0.3 mm. The second wood-drilling device 12a of the two wood-drilling devices 10a, 12a has a cutting body 24a with a maximum diameter 20a perpendicular to the rotation axis 22a of a maximum of 22.5 mm. In particular, the cutting body 24a of the second wood-drilling device 12a has the discrete maximum diameter 20a of 13.0 mm, 16.2 mm, 19.4 mm or 22.5 mm, in particular with a tolerance of a maximum of 0.3 mm.

The wood-drilling devices 10a, 12a in each case comprise a drill tip 26a, 28a, a cutting body 18a, 24a, and a drill shank 30a, 32a, which together in each case form a drilling unit 34a, 36a. The drilling units 34a, 36a are, in particular, in each case formed from a material composition. The drilling units 34a, 36a are, in particular, in each case made of spring steel. The drilling units 34a, 36a are formed from the same spring steel.

The drilling units 34a, 36a have a number of distinguishable hardness regions 38a, 40a, 42a, 44a, 46a, in particular as measured according to Rockwell, which is dependent on a maximum extension 192a of the cutting body 18a, 24a perpendicular to the rotation axis 16a, 22a, in particular the maximum diameter 14a, 20a of wood-drilling device 10a, 12a. The first wood-drilling device 10a, in particular a drilling unit 34a of the first wood-drilling device 10a, has three distinguishable first hardness regions 38a, 40a, 42a, in particular as measured according to Rockwell. The second wood-drilling device 12a, in particular a drilling unit 36a of the wood-drilling device 12a, has two distinguishable second hardness regions 44a, 46a, in particular as measured according to Rockwell. However, a different number of hardness regions 38a, 40a, 42a, 44a, 46a that appear to be useful to a person skilled in the art would also be conceivable.

The first wood-drilling device 10a differs from the second wood-drilling device 12a by a different maximum diameter 14a, 20a perpendicular to the rotation axis 16a, 22a. Different sets of multiple wood-drilling devices 10a, 12a are provided for different machine tools 202a. For each set of wood-drilling devices 10a, 12a, there is a limit value for the maximum diameter 14a, 20a perpendicular to the rotation axis 16a, 22a of wood-drilling devices 10a, 12a, which determines how many distinguishable hardness regions 38a, 40a, 42a, 44a, 46a the respective wood-drilling devices 10a, 12a comprise. In this example, the maximum diameter limit 14a, 20a perpendicular to the rotation axis 16a, 22a of the wood-drilling devices 10a, 12a is approximately 22.5 mm. It is conceivable that the limit value for the maximum diameter 14a, 20a perpendicular to the rotation axis 16a, 22a of the wood drilling devices 10a, 12a, which determines how many distinguishable hardness regions 38a, 40a, 42a, 44a, 46a the respective wood drilling devices 10a, 12a have, here exemplarily consisting of two distinguishable hardness regions 38a, 40a or three distinguishable hardness regions 42a, 44a, 46a, varies for different machine tools 202a. It is conceivable that the limit value, in particular for the maximum diameter 14a, 20a perpendicular to the rotation axis 16a, 22a of the wood drilling devices 10a, 12a, which in particular determines how many distinguishable hardness areas 38a, 40a, 42a, 44a, 46a the respective wood drilling devices 10a, 12a have, can assume values between 5 mm and 50 mm, for example 20 mm, 17.5 mm or 15 mm or also 25 mm, 27.5 mm or 30 mm. For example, the limit value can increase as the power of the machine tools 202a increases due to an increased load on the drill shank 30a, 32a, and decrease as the power of the machine tools 202a decreases due to a decreased load on the drill shank 30a, 32a.

The wood-drilling devices 10a, 12a are provided, in particular designed, for drilling, in particular impact drilling, a wood material containing metal fragments in particular.

The wood-drilling devices 10a, 12a in each case comprise a drill shank 30a, 32a. The drill shanks 30a, 32a, in particular in each case, are provided in sections for clamping on a machine tool 202a. The wood-drilling devices 10a, 12a in each case comprise a drill tip 26a, 28a. The drill tips 26a, 28a in each case have a thread 48a, 50a, in particular. The wood-drilling devices 10a, 12a in each case comprise a cutting body 18a, 24a. The cutting bodies 18a, 24a, in particular in each case, are intended for cutting wood material. The wood-drilling devices 10a, 12a in each case define the rotation axes 16a, 22a.

The drilling units 34a, 36a are, in particular, in case each formed in one piece. More particularly, the drill tip 26a, 28a and cutting body 18a, 24a of each wood-drilling device 10a, 12a are formed in one piece. In particular, the cutting body 18a, 24a and the drill shank 30a, 32a are formed in one piece. In particular, one-piece objects are produced by production in a forging process from a single blank.

Subsequently, the first wood-drilling device 10a is described representatively of both wood-drilling devices 10a, 12a.

The drill tip 26a is connected to the cutting body 18a at an end of the cutting body 18a facing away from the drill shank 30a. The drill shank 30a is connected to the cutting body 18a at an end of the cutting body 18a facing away from the drill tip 26a. The drilling unit 34a is formed materially symmetrically around the rotation axis 16a. In this example, the drilling unit 34a is formed free of cavities inside the drilling unit 34a. In a case of a sintered drilling unit 34a, it is conceivable that the drilling unit 34a can have cavities, in particular due to production. The drilling unit 34a materially extends along the rotation axis 16a, wherein a portion of the rotation axis 16a extending between an end of the drill tip 26a facing away from the drill shank 30a to an end of the drill shank 30a facing away from the drill tip 26a exclusively through a material portion of the drilling unit 34a. The cutting body 18a has a greater maximum radius, in particular the diameter 14a; in particular, a greater maximum extension 192a perpendicular to the rotation axis 16a than the drill shank 30a.

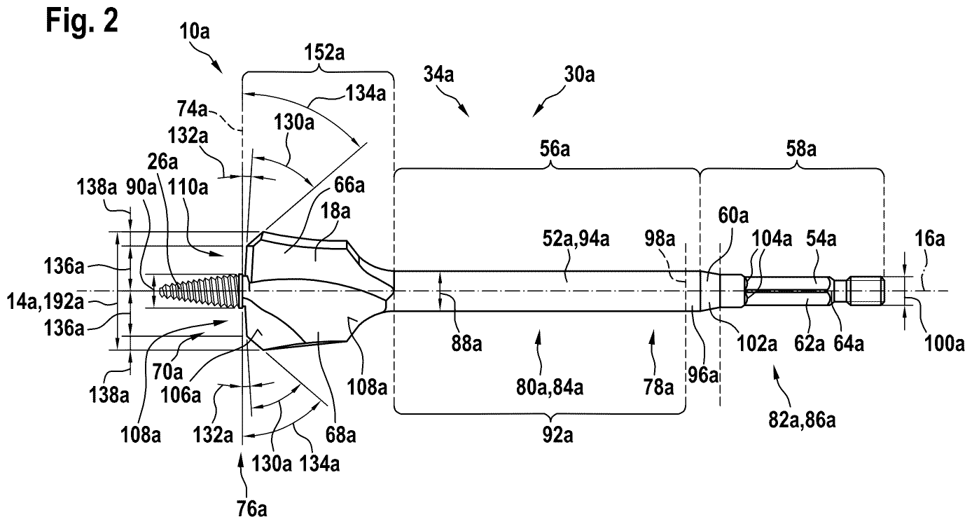

FIG. 2 shows that the drill shank 30a has a shank body 52a and a tool connecting body 54a. The drill shank 32a has a shank body 52a. The drill shank 32a has a tool connecting body 54a. The shank body 52a and tool connecting body 54a are directly connected to each other. The shank body 52a and the tool connecting body 54a are formed in one piece. A maximum extension 56a of the shank body 52a is shown in FIG. 2. A maximum extension 58a of the tool connecting body 54a is shown in FIG. 2. The shank body 52a has a uniform diameter 88a in this example. The cutting body 18a has a larger diameter at a boundary to the shank body 52a, in particular a greater maximum extension 192a perpendicular to the rotation axis 16a, than the shank body 52a. The shank body 52a has a larger diameter at a boundary to the tool connecting body 54a, in particular a greater maximum extension 192a perpendicular to the rotation axis 16a, than the tool connecting body 54a.

The shank body 52a is arranged between the tool connecting body 54a and the cutting body 18a. The shank body 52a has two different hardness regions 40a, 42a, in particular as measured according to Rockwell. The shank body 52a has a uniform diameter 88a, which is smaller than a maximum diameter 14a of the cutting body 18a, in particular as a maximum extension 192a of the cutting body 18a perpendicular to the rotation axis 16a. The shank body 52a has a uniform diameter 88a which is smaller than an average diameter of the cutting body 18a, in particular as an average maximum extension 192a of the cutting body 18a taken along the rotation axis 16a, perpendicular to the rotation axis 16a. The shank body 52a has a uniform diameter 88a, which is larger than a maximum diameter 90a of the drill tip 26a. The shank body 52a has a uniform diameter 88a, which is larger than an average diameter of the drill tip 26a. The shank body 52a connects the cutting body 18a to the tool connecting body 54a. The cutting body 18a is spaced apart from the tool connecting body 54a about a maximum extension 56a of the shank body 52a along the rotation axis 16a.

The tool connecting body 54a is provided in sections for clamping to the machine tool 202a. An operating state of the wood-drilling device 10a is a state in which the wood-drilling device 10a is clamped to the machine tool 202a and driven to rotate about the rotation axis 16a by the machine tool 202a. In this example, the shank body 52a has a uniformly sized cross-section perpendicular to the rotation axis 16a. In this example, the shank body 52a has a uniformly shaped cross-section perpendicular to the rotation axis 16a. The shank body 52a is arranged between the cutting body 18a and the tool connecting body 54a. The shank body 52a has a circular outer contour in a cross-section perpendicular to the rotation axis 16a.

The tool connecting body 54a has a transition region 60a and a coupling region, in particular a hex region 62a. The tool connecting body 54a has a transition region 60a. The tool connecting body 54a has a coupling region, in particular a hex region 62a. Only the hex region 62a of the tool connecting body 54a is provided for clamping on the machine tool 202a. The hex region 62a is designed, in particular formed, to be clamped to the machine tool 202a. The tool connecting body 54a has a cross-section in the hex region 62a perpendicular to the rotation axis 16a, with a hexagonal outer contour. The transition region 60a is arranged between the hex region 62a and the shank body 52a. The tool connecting body 54a has various cross-sections perpendicular to the rotation axis 16a as viewed in the transition region 60a along the rotation axis 16a, wherein the cross-sections have an outer contour, forming a continuous transition between a hexagonal outer contour such as the tool connecting body 54a and a circular outer contour, such as that of the shank body 52a. The hex region 62a forms an end of the drilling unit 34a that faces away from the drill tip 26a. The hex region 62a has a partial hex region 64a, in which the hex region 62a is tapered for a lock-in clamping on the machine tool 202a.

In particular, the hex region 62a in the partially hex region 64a has a cross-section perpendicular to the rotation axis 16a, which has a non-uniformly shaped outer contour. In particular, the hex region 62a in the partially hex region 64a has a cross-section perpendicular to the rotation axis 16a, which has an outer contour of hexagonal difference, in particular a circular outer contour.

The cutting body 18a has two symmetrically, in particular two-count symmetrically, arranged cutting wings 66a, 68a relative to the rotation axis 16a of the cutting body 18a. A maximum radius, in particular a diameter 14a, in particular a maximum extension 192a of the cutting body 18a perpendicular to the rotation axis 16a, of the drilling unit 34a, in particular the wood-drilling device 10a, is formed in relation to the rotation axis 16a on the cutting wings 66a, 68a. The two cutting wings 66a, 68a are arranged opposite each other in relation to the rotation axis 16a. A cutting wing 66a, 68a is to be interpreted as a part of the cutting body 18a that projects radially in a direction from the rotation axis 16a, in particular opposite a central portion of the cutting body 18a in which the cutting body 18a is formed fully symmetrically around the rotation axis 16a. The cutting body 18a has non-uniform maximum transverse extensions, in particular non-uniform maximum diameters 14a, perpendicular to the rotation axis 16a as viewed along the rotation axis 16a.

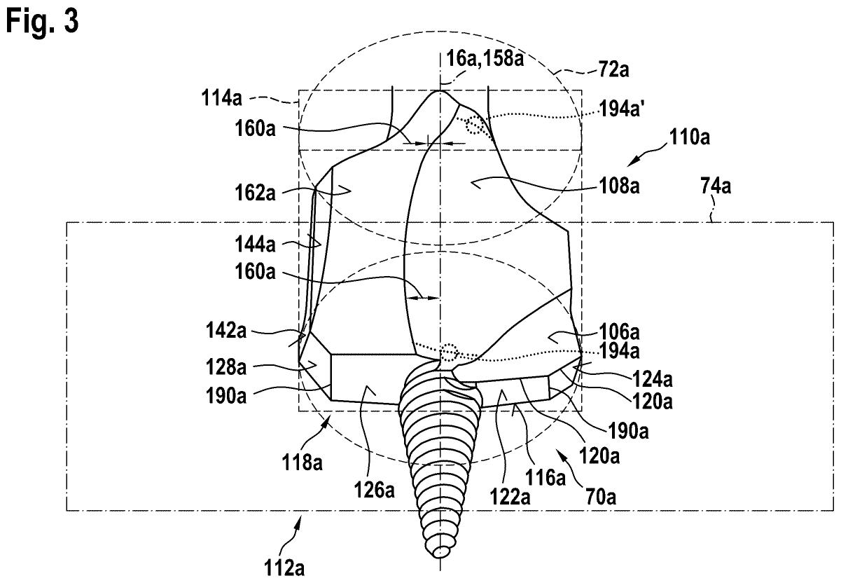

The cutting body 18a has a base side 70a. The base side 70a is defined in relation to an imaginary smallest cylinder 72a, which has a cylinder axis, which is identical to the rotation axis 16a and only just completely encompasses the cutting body 18a (see FIG. 3). The base side 70a of the cutting body 18a is one side of the cutting body 18a which faces the drill tip 26a and faces a base side 70a of the smallest imaginary cylinder 72a. The base side 70a of the cutting body 18a defines an imaginary drill plane 74a (see FIG. 2 and FIG. 3). The drill plane 74a is an imaginary plane, which is oriented perpendicular to the rotation axis 16a and which is arranged on an end of the cutting body 18a facing the drill tip 26a, between the drill tip 26a and the cutting body 18a. The imaginary drill plane 74a is arranged directly adjacent to the cutting body 18a.

The drilling unit 34a comprises at least two distinguishable hardness regions 38a, 40a, 42a, in particular as measured according to Rockwell. The drill shank 30a has a hardness that partially differs from the drill tip 26a, in particular as measured according to Rockwell. The drilling unit 34a comprises at least two distinguishable hardness regions 38a, 40a, 42a, in particular as measured according to Rockwell, which differ by more than 10 HRC. The at least two distinguishable hardness regions 38a, 40a, 42a differ by at least 10 HRC, in particular as measured according to Rockwell. The distinguishable hardness regions 38a, 40a, 42a are separated from each other by at least one hardness limit 98a.

A hardness region 38a of the at least two hardness regions 38a, 40a, 42a is formed as a peak hardness region 76a. The tip hardness region 76a is formed by the drill tip 26a and the cutting body 18a.

The drill tip 26a and cutting body 18a are of the same hardness in this example, in particular as measured according to Rockwell. The drill tip 26a and cutting body 18a form the tip hardness region 76a, which has a uniform hardness. The hardness of the peak hardness region 76a differs from a hardness of the drill shank 30a, in particular an average hardness.

A hardness region 38a of the at least two hardness regions 38a, 40a, 42a, in particular the peak hardness region 76a, has a hardness of at least 53 HRC, in particular as measured according to Rockwell. A hardness region 38a of the at least two hardness regions 38a, 40a, 42a, in particular the peak hardness region 76a, has a hardness of a maximum of 58 HRC, in particular as measured according to Rockwell. A hardness region 38a of the at least two hardness regions 38a, 40a, 42a, in particular the peak hardness region 76a, has a hardness of between 53 HRC and 58 HRC, in particular as measured according to Rockwell.

At least one hardness region 40a, 42a of the at least two hardness regions 38a, 40a, 42a is formed as a shank hardness region 78a, which is formed by the shank body 52a or the tool connecting body 54a for the first wood-drilling device 10a, and by the shank body 52a and the tool connecting body 54a for the second wood-drilling device 12a.

At least one hardness region 40a, 42a of the at least two hardness regions 38a, 40a, 42a, in particular the shank hardness region 78a, has a hardness of at least 30 HRC, in particular as measured according to Rockwell. At least one hardness region 40a, 42a of the at least two hardness regions 38a, 40a, 42a, in particular the shank hardness region 78a, has a hardness of a maximum of 58 HRC, in particular as measured according to Rockwell. At least one hardness region 40a, 42a of the at least two hardness regions 38a, 40a, 42a, in particular the shank hardness region 78a, has a hardness of between 30 HRC and 40 HRC for the second wood-drilling rig 12a, and a hardness of between 30 HRC and 45 HRC for the first wood-drilling rig 10a, or between 53 HRC and 58 HRC, in particular as measured according to Rockwell.

Only for the first wood-drilling device 10a, the shank hardness region 78a is formed by two partial shank hardness regions 80a, 82a, in particular a shank body hardness region 84a, which is completely formed by the shank body 52a, and a tool connecting body hardness region 86a, which is for the most part formed by the tool connecting body 54a and partially by the shank body 52a. For the second wood-drilling device 10a, the shank hardness region 78a is designed as a region with a uniform, in particular constant, hardness.

A partial shank hardness region 80a of the at least two partial shank hardness regions 80a, 82a, in particular the shank body hardness region 84a, has a hardness of at least 30 HRC, in particular as measured according to Rockwell. A partial shank hardness region 80a of the at least two shank hardness regions 80a, 82a, in particular the shank body hardness region 84a, has a hardness of a maximum of 45 HRC, in particular as measured according to Rockwell. A partial shank hardness region 80a of the at least two partial shank hardness regions 80a, 82a, in particular the shank body hardness region 84a, has a hardness of between 30 HRC and 45 HRC, in particular as measured according to Rockwell.

A partial shank hardness region 82a of the at least two partial shank hardness regions 80a, 82a, in particular the tool connecting hardness region 86a, has a hardness of at least 53 HRC, in particular as measured according to Rockwell. A partial hardness region 82a of the at least two partial hardness regions 80a, 82a, in particular the tool connecting body hardness region 86a, has a hardness of a maximum of 58 HRC, in particular as measured according to Rockwell. A partial shank hardness region 82a of the at least two partial shank hardness regions 80a, 82a, in particular the tool connecting hardness region 86a, has a hardness of between 53 HRC and 58 HRC, in particular as measured according to Rockwell.

The hardness of the tip hardness region 76a differs from the hardness of the shank hardness region 78a, in particular the shank body hardness region 84a and/or the tool connecting hardness region 86a, by at least 8 HRC.

The wood-drilling device 10a has a coating that partially encases the drilling unit 34a. The coating is formed from a material composition that differs from the material composition from which the drilling unit 34a is formed. In particular, the cutting body 18a and the drill tip 26a are coated as part of the drilling unit 34a.

The shank body 52a and tool connecting body 54a have different levels of hardness on average, in particular as measured according to Rockwell. The shank body hardness region 84a and the tool connecting hardness region 86a have different levels of hardness. The shank body hardness region 84a and the tool connecting body hardness region 86a have different levels of hardness, which differ by at least 10 HRC.

The shank body 52a in each case partially forms the shank body hardness region 84a and the tool connecting body hardness region 86a. The shank body 52a in ease case partially has the shank body hardness region 84a and the tool joint body hardness region 86a.

A portion of the shank body 52a completely forms the shank body hardness region 84a, in particular. The portion of the shank body 52a forming the shank body hardness region 84a extends from the cutting body 18a along the rotation axis 16a around an extension 92a towards the tool connecting body 54a, which is shorter than the maximum extension 56a of the shank body 52a. The shank body hardness region 84a is formed solely by the shank body 52a. A greater part 94a of the shank body 52a facing the cutting body 18a completely forms the shank body hardness region 84a. The greater part 94a comprises a maximum of 96% of the shank body 52a by volume, in particular from an end of the shank body 52a facing the cutting body 18a. It is also conceivable that the greater part comprises less than 96%, in particular at most 80%, of the shank body 52a by volume, in particular of an end of the shank body 52a facing the cutting body 18a.

A portion of the shank body 52a partially forms the tool connecting body hardness region 86a. A minority portion 96a of the shank body 52a facing the tool connecting body 54a forms at least 4% of the tool connecting body hardness region 86a, in particular at least 20%, by volume. The minority portion 96a is an end of shank body 52a that faces the tool connecting body 54a.

The shank body 52a has a hardness limit 98a. The hardness limit 98a divides the shank body 52a into two hardness regions 40a, 42a with different levels of hardness. The hardness limit 98a is arranged so that it is spaced apart from the tool connecting body 54a.

The hardness limit 98a delimits the tool connecting body hardness region 86a from the shank body hardness region 84a. The hardness limit 98a is arranged so that it is spaced apart at least 3 mm at one end, in particular an end facing the tool connecting body 54a, from the shank body 52a on the shank body 52a.

The hardness limit 98a is perpendicular to the rotation axis 16a. The shank body 52a is a part of the drill shank 30a with a uniform diameter 88a, between the insert 18a with a larger average diameter, and the tool connecting body 54a with a smaller average diameter. The shank body 52a terminates along the rotation axis 16a exactly where the diameter of the drilling unit 34a changes. The hardness limit 98a is spaced apart from a geometric boundary between the shank body 52a and the tool connecting body 54a.

The shank body 52a and the tool connecting body 54a are of different diameters on average. The shank body 52a has a uniform diameter 88a, which is larger than an average diameter of the tool connecting body 54a. The tool connecting body 54a has a smaller diameter 100a, in particular a smaller maximum extension perpendicular to the rotation axis 16a, at an end facing away from the shank body 52a, than the shank body 52a.

The transition region 60a is arranged between the shank body 52a and the hex region 62a. The transition region 60a has different diameters.

The tool connecting body 54a has a hex region 62a on a side facing away from the shank body 52a, in particular the end. In the hex region 62a, the tool connecting body 54a has a hexagonal outer contour in a cross-section perpendicular to the rotation axis 16a. The tool connecting body 54a has the transition region 60a on a side that faces the shank body 52a, in particular the end. In the transition region 60a, the tool connecting body 54a has a circular outer contour in a cross-section perpendicular to the rotation axis 16a. The tool connecting body 54a has a diameter in the transition region 60a, in particular the maximum extensions perpendicular to the rotation axis 16a, which have a size between a diameter 100a, in particular maximum extensions perpendicular to the rotation axis 16a, the hex region 62a and the diameter 88a, in particular maximum extensions perpendicular to the rotation axis 16a, of the shank body 52a. The transition region 60a has a maximum extension parallel to the rotation axis 16a of a maximum of 15 mm. The transition region 60a has a minimum extension parallel to the rotation axis 16a of at least 5 mm.

The tool connecting body 54a has a tapered region 102a. The transition region 60a is partially formed as the tapered region 102a. In the tapered region 102a, the size of the diameter 100a of the tool connecting body 54a is linearly aligned from the diameter 100a, in particular maximum extensions 192a perpendicular to the rotation axis 16a, hex range 62a to the diameter 88a, in particular the maximum extension perpendicular to the rotation axis 16a, of the shank body 52a. The outer contour of the tapered region 102a forms a 10° angle in relation to the rotation axis 16a. The outer contour of the tapered region 102a can form an angle between 6° and 15° in relation to the rotation axis 16a.

The transition region 60a has a maximum extension parallel to the rotation axis 16a of a maximum of 10 mm. The tapering region 102a has a minimum extension parallel to the rotation axis 16a of at least 3 mm.

The tapered region 102a has a circular cross-section perpendicular to the rotation axis 16a. The hex region 62a has six toothed elements 104a at an end facing the tapering region 102a.

The toothed elements 104a are arranged at the hex region 62a such that the toothed elements 104a have a hexagonal cross-section which has the hex region 62a at an end facing away from the tapering region 102a and is aligned with the circular cross-section of the tapering region 102a. The toothed elements 104a are formed in one piece with the tool connecting body 54a, in particular at the hex region 62a and at the transition region 60a. In each case, one toothed element 104a is arranged externally on each outer surface of the hexagonal outer contour of the hex region 62a. The toothed elements 104a extend in tooth form from the transition region 60a along the rotation axis 16a to the hex region 62a.

The cutting body 18a, on at least one sheath outer side 110a, 112a which is defined in particular in relation to the imaginary cylinder 72a about the rotation axis 16a, has a cutting surface 106a for cutting the wood material and/or the metal fragments. The cutting body 18a has a chip conveying surface 108a for cutting the wood material and/or the metal fragments on at least one outer sheath 110a, 112a, which is defined about the rotation axis 16a in particular in relation to the imaginary cylinder 72a. The chip conveying surface 108a is designed to convey chips along the rotation axis 16a as viewed in the direction of the bore shank 30a away from the rotation axis 16a.

The cutting body 18a has two sheath outer sides 110a, 112a. The sheath outer sides 110a, 112a of the cutting body 18a are located on the sheath side of the cylinder 72a, the sides of the cutting body 18a, which face the largest outer surfaces of a smallest imaginary cuboid 114a. The two outer sheath sides 110a, 112a are designed analogously to each other, in particular in the same manner, in particular symmetrically to each other.

The two outer sheath faces 110a, 112a in each case have a chipping surface 106a for cutting off the wood material and/or the metal fragments and a chip conveying surface 108a which is adjacent to the chipping surface 106a, and which is partially concave and partially has a convex curvature.

The cutting wings 66a, 68a, in particular in each case, have a cutting surface 116a, 118a. The cutting surfaces 116a, 118a are arranged spaced apart from the rotation axis 16a by a maximum thickness, in particular the diameter 90a, of the drill tip 26a, in particular perpendicular to the rotation axis 16a.

The cutting surfaces 116a, 118a are arranged on the base side 70a facing the drill tip 26a, which is defined about the rotation axis 16a, in particular in relation to the imaginary cylinder 72a. The two cutting surfaces 116a, 118a on the cutting body 18a are arranged symmetrically in relation to each other about the rotation axis 16a.

An edge 120a of the cutting surface 116a, 118a is designed to remove, cut, and/or chip the wood material and/or the metal fragments in the wood material, in particular in the operating state of the wood-drilling device 10a. The edge 120a of the cutting surface 116a, 118a is formed as the edge 120a of the cutting surface 106a. The edge 120a of the chipping surface 106a to the cutting face 116a, 118a is designed to remove, cut, and/or chip the wood material and/or the metal fragments in the wood material, in particular in the operating state of the wood-drilling device 10a.

The, preferably every one of the, cutting surfaces 116a, 118a are formed by two directly adjacent cutting partial surfaces 122a, 124a, 126a, 128a, in particular forming one common boundary cutting edge 190a towards each other. The, preferably every one of the, cutting surfaces 116a, 118a are formed by at least two, in particular exactly two, adjacent cutting part surfaces 122a, 124a, 126a, 128a, in particular along an increasing diameter 14a, that are angled from the drill plane 74a in the direction of the drill shank 30a.

The two cutting partial surfaces 122a, 124a, 126a, 128a of, in particular, each of the cutting surfaces 116a, 118a are angled towards each other at an angle 130a. The two cutting partial surfaces 122a, 124a, 126a, 128a of, in particular, each of the cutting surfaces 116a, 118a are angled towards each other at an angle 130a of 40° (see FIG. 2). The two cutting partial surfaces 122a, 124a, 126a, 128a of, in particular, each of the cutting surfaces 116a, 118a are arranged adjacent to one another without offsets, in particular along the rotation axis 16a. The two cutting partial surfaces 122a, 124a, 126a, 128a of, in particular, each of the cutting surfaces 116a, 118a are arranged adjacent to each other. The two cutting partial surfaces 122a, 124a, 126a, 128a of, in particular, each of the cutting surfaces 116a in each case have a 0° different angle to the rotation axis 16a. The two cutting partial surfaces 122a, 124a, 126a, 128a of, in particular, each of the cutting surfaces 116a, 118a in each case have an angle 132a, 134a, which differs from 0°, 90°, or 180° in relation to the rotation axis 16a.

The two cutting part surfaces 122a, 124a, 126a, 128a of, in particular, each of the cutting surfaces 116a, 118a are angled from the drill plane 74a oriented perpendicular to the rotation axis 16a in the direction of the drill shank 30a.

The two cutting partial surfaces 122a, 124a, 126a, 128a are formed as flat surfaces. The two cutting partial surfaces 122a, 124a, 126a, 128a, in particular each of the cutting surfaces 116a, 118a, are in each case formed as flat surfaces, wherein, in particular, each point of the surface of the two cutting partial surfaces 122a, 124a, 126a, 128a, in particular the, in particular each, of the cutting surfaces 116a, 118a, is arranged in a two-dimensional plane within production tolerances. The two cutting partial surfaces 122a, 124a, 126a, 128a, in particular in each case, are angled along a direction perpendicular to a greatest extension 192a of the cutting body 18a perpendicular to the rotation axis 16a from the drill plane 74a towards the drill shank 30a.

The two cutting partial surfaces 122a, 124a, 126a, 128a, in particular, are in each case angled along a direction perpendicular to a greatest extension 192a of the cutting body 18a perpendicular to the rotation axis 16a from the drill plane 74a towards the drill shank 30a at an angle 132a, 134a of at least 5°, in particular within tolerances of a maximum of 1°. The two cutting partial surfaces 122a, 124a, 126a, 128a are angled along a direction perpendicular to a greatest extension 192a of the cutting body 18a perpendicular to the rotation axis 16a from the drill plane 74a towards the drill shank 30a at an equal angle, in particular within tolerances of a maximum of 1°.

The cutting partial surfaces 122a, 126a of the cutting partial surfaces 122a, 124a, 126a, 128a facing the drill tip 26a have an angle 132a of 5° to the drill plane 74a apart from deviations of a maximum of 2°.

The two cutting partial surfaces 122a, 124a, 126a, 128a of each cutting surface 116a, 118a, are, in particular, angled along an increasing diameter 14a, preferably along the increasing greatest extent 192a of the cutting body 18a perpendicular to the rotation axis 16a, from the drill plane 74a towards the drill shank 30a at an angle 132a, 134a of at least 5°, in particular with a tolerance of 2°.

The cutting partial surfaces 124a, 128a of the cutting partial surfaces 122a, 124a, 126a, 128a facing away from the drill tip 26a have an angle 134a of 45° to the drill plane 74a apart from deviations of a maximum of 5°.

The cutting partial surfaces 124a, 128a of the cutting partial surfaces 122a, 124a, 126a, 128a facing away from the drill tip 26a are angled along an increasing diameter 14a, preferably along the increasing greatest extension 192a of the cutting body 18a perpendicular to the rotation axis 16a, from the drill plane 74a towards the drill shank 30a at a maximum angle 134a of 45°, in particular with a maximum tolerance of 3°.

The cutting partial surfaces 122a, 126a of the cutting partial surfaces 122a, 124a, 126a, 128a that are arranged facing the drill tip 26a have a maximum extension 136a perpendicular to the rotation axis 16a which extends twice as far as a maximum extension 138a perpendicular to the rotation axis 16a of a cutting partial surface 124a, 128a of the two cutting partial surfaces 122a, 124a, 126a, 128a of each cutting surface 116a, 118a arranged facing away from the drill tip 26a.

The cutting wings 66a, 68a have two radial outer surfaces 142a, 144a that are angled to one another over a radial edge 140a. The radial outer surfaces 142a, 144a are arranged at a free end of the respective cutting wing 66a, 68a radially facing away from the rotation axis 16a, at a maximum distance from the rotation axis 16a. The radial edge 140a extends parallel to the rotation axis 16a, apart from deviations of a maximum of 10°. The radial outer surfaces 142a, 144a are arranged at a free end of the respective cutting wing 66a, 68a radially facing away from the rotation axis 16a, at a maximum distance from the rotation axis 16a. The radial edge 140a is arranged at an outer surface 146a of the cutting body 18a, which is maximally spaced apart from the rotation axis 16a perpendicular to the rotation axis 16a. The radial outer surfaces 142a, 144a consist of the outer surfaces of the cutting body 18a, which are arranged on average the farthest away, in particular from all outer surfaces of the cutting body 18a, from the rotation axis 16a. The radial outer surfaces 142a, 144a are arranged on a radial outer side 148a of the cutting body 18a. The radial outer side 148a consists of one side of the cutting body 18a, which is arranged radially farthest away, in particular from all sides of the cutting body 18a, from the rotation axis 16a.

The cutting body 18a has two radial outer sides 148a, which are equidistant on average from the rotation axis 16a.

The radial outer surfaces 142a, 144a are arranged on a sheath side of the cutting body 18a, wherein the sheath side of the cutting body 18a is defined in particular analogously to a sheath side of the smallest imaginary cylinder 72a, which has a cylinder axis, which is identical to the rotation axis 16a and only just completely encloses the cutting body 18a. The radial edge 140a is arranged on the sheath side of the cutting body 18a. The radial edge 140a is an outer edge of the cutting body 18a, which separates the two outer surfaces, which are on average the farthest away, in particular from all outer surfaces of the cutting body 18a, from the rotation axis 16a.

The cutting body 18a has two radial outer surfaces 142a, 144a that are angled to each other on each cutting wing 66a, 68a, which are in particular separated from each other in each case by a radial edge 140a, which in particular extends parallel to the rotation axis 16a apart from deviations of a maximum of 10°. Each of the two radial outer surfaces 142a, 144a is concavely angled to each other on each cutting wing 66a, 68a in each case as viewed from the rotation axis 16a. The two radial outer surfaces 142a, 144a are angled to one another at an angle of 19°, in particular with a tolerance of a maximum of 6°. An outer edge, which differs from the radial edge 140a, in particular a radial outer edge 210a, of the two radial outer surfaces 142a, 144a defines the greatest extension 192a, in particular the maximum diameter 14a, of the cutting body 18a perpendicular to the rotation axis 16a. Two outer edges, in particular radial outer edges 210a, of the two radial outer surfaces 142a, 144a of the two cutting wings 66a, 68a, which are perpendicular to the rotation axis 16a and are opposite the radial edges 140a, define the greatest extension 192a, in particular the maximum diameter 14a, of the cutting body 18a perpendicular to the rotation axis 16a.

The chip conveying surface 108a abuts the chipping surface 106a. The chipping surface 106a is formed completely concavely. The chipping surface 106a abuts a cutting surface 116a, 118a. The chipping surface 106a and the chip conveying surface 108a separated from one another by a protruding edge, in particular a boundary edge 150a. The chipping surfaces 106a in each case abut the drill tip 26a, one of the cutting surfaces 116a, 118a, in particular in each case two cutting partial surfaces 122a, 124a, 126a, 128a, one radial outer surface 142a of the two radial outer surfaces 142a, 144a, and the chip conveying surface 108a.

Each chip conveying surface 108a extends from the drill tip 26a to less than 10 mm to the drill shank 30a, in particular to the shank body 52a.

Each chip conveying surface 108a extends along the rotation axis 16a over at least 95% of a maximum extension 152a of the cutting body 18a from the drill tip 26a towards the drill shank 30a via the cutting body 18a (see FIG. 2).

The chip conveying surface 108a is partially concave and partially has a convex curvature. The chip conveying surface 108a is continuously formed so that it is partially concave and partially has a convex curvature along a view on its surface perpendicular to the rotation axis 16a. The chip conveying surface 108a is formed with a rather convex curvature at an end facing the drill shank 30a. The chip conveying surface 108a is formed with a rather concave curvature at an end facing the drill shank 30a. A center point 194a, 194a′ of an extension of the chip conveying surface 108a perpendicular to the rotation axis 16a on the chip conveying surface 108a is arranged on the drill tip 26a closer to the rotation axis 16a than on the drill shank 30a (see FIG. 3).

The cutting body 18a, on the outer lateral sides 110a, 112a, in particular in each case, has a raised edge 154a which extends from an end region of the cutting body 18a facing the drill tip 26a to an end region of the cutting body 18a facing the drill shank 30a and which, at the end region of the cutting body 18a facing the drill tip 26a, has a different average distance 160a from a plane 158a spanned by the rotation axis 16a, which is aligned perpendicular to the rotation axis 16a up to a deviation of at most 25° from a maximum extension 192a, in particular the maximum diameter 14a, of the cutting body 18a, than at an end region of the cutting body 18a facing the drill shank 30a (see FIG. 2).

The two outer sheath sides 110a, 112a in each case have a raised edge 154a. The raised edges 154a are outwardly projecting edges of the sheath outer sides 110a, 112a, in particular of the cutting body 18a. The two raised edges 154a are formed symmetrically in relation to each other, in particular in relation to the rotation axis 16a. In particular, the raised edges 154a are edges on the sheath outer sides 110a, 112a which are formed by material local high points 156a, in particular of the cutting body 18a away from the rotation axis 16a, at a midpoint of a greatest extension of the sheath outer side 110a, 112a perpendicular to the rotation axis 16a. At the end region of the cutting body 18a facing the drill tip 26a, the two raised edges 154a have a greater average distance 160a from the plane 158a spanned by the rotation axis 16a, which is aligned perpendicularly to a maximum deviation of 25 from a maximum extension 192a of the cutting body 18a perpendicularly to the rotation axis 16a, than at an end region of the cutting body 18a facing the drill shank 30a (see FIG. 2). The elevation edge 154a, in particular, limits the length of the elevation edge 154a, the at least one chip conveying surface 108a, against a further outer surface of the sheath outer side 110a, 112a, in particular a back surface 162a. The raised edges 154a follow an arcuate path as viewed along the rotation axis 16a. The raised edges 154a delineate the chip conveying surface 108a from the back surface 162a of the sheath outer side 110a, 112a. A raised edge 154a extends across each sheath outer side 110a, 112a from the end of the cutting body 18a facing the drill tip 26a to the end of the cutting body 18a facing the drill shank 30a, limiting the chip conveying surface 108a from the back surface 162a of the sheath outer side 110a, 112a, wherein the raised edges 154a have an arcuate path as viewed along the rotation axis 16a.

The raised edges 154a are formed by the high points 156a of the sheath outer sides 110a, 112a, wherein the high points 156a are defined relative to a body plane along the rotation axis 16a and the greatest extension 192a of the cutting body 18a perpendicular to the rotation axis 16a, in particular the maximum diameter 14a of the cutting body 18a. The high points 156a, in a cross-section perpendicular to the rotation axis 16a, represent the points of the sheath outer sides 110a, 112a, which are at the greatest distance to the body plane in the respective cross-section. The raised edge 154a has a greater maximum extension than the maximum extension 152a of the cutting body 18a parallel to the rotation axis 16a, due to the arcuate path.

The chipping surface 106a is arranged on the sheath outer side 110a of the cutting body 18a at one end that faces the drill tip 26a, in particular the cutting body 18a. The chipping surface 106a forms a greater part of a constant chipping angle 168a of 18° relative to the rotation axis 16a.

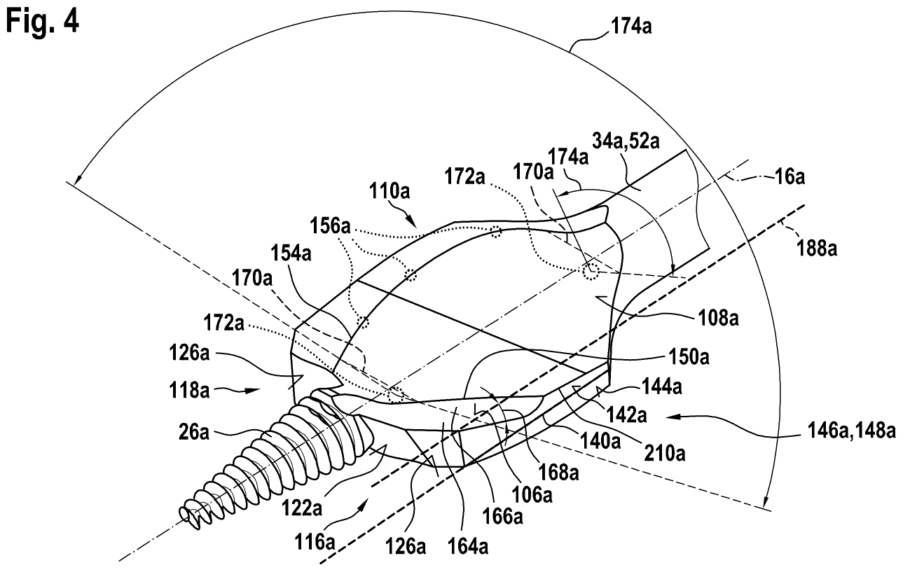

The chipping surface 106a is formed by a transition region 164a and a constant region 166a. The chipping surface 106a forms a constant chipping angle 168a of 18° to the rotation axis 16a at an end of the chipping surface 106a facing the drill tip 26a, in particular with a maximum tolerance of 4° (see FIG. 4). In particular, FIG. 4 shows an auxiliary line 188a, which runs parallel to the rotation axis 16a. The transition region 164a is rounded. The chipping surface 106a forms a constant chipping angle 168a of 18° to the rotation axis 16a, in particular in relation to the chip conveying surface 108a, except in the rounded transition region 164a of the chipping surface 106a, in particular with a maximum tolerance of 4°. The constant region 166a is a region of the chipping surface 106a with a planar outer surface, which, in particular, forms the constant chipping angle 168a of 18°. The transition region 164a is a region of the chipping surface 106a in which the chipping surface 106a is bent, in particular rounded, in particular to form a gliding transition for chips from the chipping surface 106a to the chip conveying surface 108a.

The transition region 164a is formed as an inward curved region, in particular in relation to the cutting body 18a, of the chipping surface 106a, with a center point of a rounded region arranged in particular outside of the cutting body 18a, in particular on a side of the cutting body 18a that faces the corresponding cutting surface 106a. The constant region 166a is formed as an inward angled region, in particular in relation to the cutting body 18a, preferably at the cutting angle 168a of 18° to the rotation axis 16a, in particular with a maximum tolerance of 4°, of the cutting surface 106a. The transition region 164a of the chipping surface 106a is formed as an inward rounded region of the chipping surface 106a.

The chipping surface 106a extends more than half as far along the rotation axis 16a as the maximum extension 192a, in particular the maximum diameter 14a, of the cutting body 18a perpendicular to the rotation axis 16a, at the radial outer surfaces 142a, 144a. The cutting surface 106a extends radially from a center of the sheath outer side 110a, in particular the cutting body 18a, to an end of the sheath outer side 110a, in particular the cutting body 18a.

The chipping surface 106a is delimited from the chip conveying surface 108a by the boundary edge 150a. The boundary edge 150a is formed as a protruding edge. The boundary edge 150a extends at least partially between the transition region 164a of the chipping surface 106a and the chip conveying surface 108a.

The chip conveying surface 108a has less of a concave curvature at an end facing the drill tip 26a than at an end of the chip conveying surface 108a facing the drill shank 30a. The two chip conveying surfaces 108a as viewed along the maximum extension 192a of the cutting body 18a perpendicular to the rotation axis 16a, in particular the maximum diameter 14a, are formed curved partially concavely, in particular curved inward in relation to the cutting body 18a, and partially convexly, in particular curved outward in relation to the cutting body 18a.

In each cross-section parallel to the drill plane 74a, in particular perpendicular to the rotation axis 16a, the chip conveying surface 108a has a point, in particular a low point 172a, which is arranged farthest away from an imaginary connecting line 170a of the, in particular radial, end points of the chip conveying surface 108a (as schematically indicated in FIG. 2). The low points 172a of the chip conveying surface 108a are less far away from the imaginary connecting line 170a of the, in particular radial, end points of the chip conveying surface 108a in an end region facing the drill tip 26a, in particular of the chip conveying surface 108a, on average over the end region than at an end region of the chip conveying surface 108a that faces the drill shank 30a.

In the cross-section perpendicular to the rotation axis 16a, the chip conveying surface 108a has a locally convex shape in a region between an end point facing the rotation axis 16a and the low point 172a. An opening angle 174a measured in a cross-section perpendicular to the rotation axis 16a at the respective low point 172a is greater in the end region of the chip conveying surface 108a that faces the drill tip 26a than at the end region of the chip conveying surface 108a that faces the drill shank 30a. A change in the opening angle 174a of the chip conveying surface 108a as viewed along the rotation axis 16a starting at the drill tip 26a is formed so that it decreases at a constant rate.

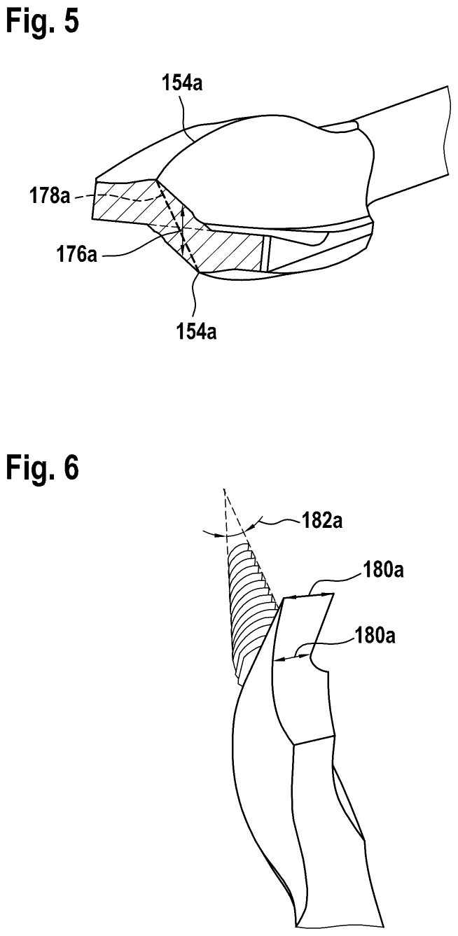

In a cross-section perpendicular to the rotation axis 16a, the cutting body 18a has a maximum thickness 176a in a body region facing the drill tip 26a, which maximum thickness is oriented perpendicular to the rotation axis 16a and, up to a deviation of at most 15°, perpendicular to the maximum extension 192a of the cutting body 18a perpendicular to the rotation axis 16a, and which intersects an imaginary connecting axis 178a through the raised edges 154a in the cross-section (see FIG. 5). The maximum thickness 176a of the cutting body 18a is oriented perpendicular to the rotation axis 16a and, up to a maximum deviation of 15, perpendicular to the maximum extension 192a of the cutting body 18a, perpendicular to the rotation axis. The imaginary connecting axis 178a through the raised edges 154a intersects the maximum thickness 176a of the cutting body 18a at exactly one point in each cross-section perpendicular to the rotation axis 16a, in particular in the central 75% of the cutting body 18a as measured by volume along the rotation axis 16a. The body region comprises a maximum of 75% of the cutting body 18a by volume from an end of the cutting body 18a that faces the drill tip 26a. In order to provide a better overview, not all reference numbers are given in FIGS. 5 to 20.

The cutting wings 66a, 68a, in a cross-section perpendicular to the rotation axis 16a and up to a deviation of no more than 15° perpendicular to a largest extension 192a of the cutting body 18a perpendicular to the rotation axis 16a, in a central region of the extension 152a of the cutting body 18a along the rotation axis 16a, in particular in the central 30% of the cutting body 18a as measured by volume along the rotation axis 16a, have a lesser extension 180a perpendicular to the rotation axis 16a and up to a deviation of no more than 15° perpendicular to the greatest extension 192a, in particular to the maximum diameter 14a, of the cutting body 18a perpendicular to the rotation axis 16a, than in an end region of the cutting body 18a that faces the drill tip 26a (see FIG. 6).

The two cutting wings 66a, 68a, in each case in a cross-section up to a deviation of no more than 15° perpendicular to the greatest extension 192a of the cutting body 18a perpendicular to the rotation axis 16a in the middle region of the maximum extension 152a of the cutting body 18a along the rotation axis 16a, in particular in the middle 30% of the cutting body 18a measured by volume along the rotation axis 16a, have a lesser extension 180a perpendicular to the rotation axis 16a and up to a deviation of at most 15° perpendicular to the largest extension 192a of the cutting body 18a perpendicular to the rotation axis 16a than in an end region of the cutting body 18a facing the drill tip 26a, in particular due to the design of the cutting surface 106a.

The drill tip 26a comprises a thread 48a with a defined thread length. The drill tip 26a is materially symmetrical about the rotation axis 16a apart from the thread 48a, and apart from deviations of no more than 10% by volume. The drill tip 26a forms an end of the drilling unit 34a that faces away from the drill shank 30a. The drill tip 26a has a thread 48a with a defined thread length of at least 12 mm, in particular up to a maximum tolerance of 1 mm. The drill tip 26a comprises a thread 48a with a defined thread length of a maximum of 20 mm, in particular up to a maximum tolerance of 1 mm. The drill tip 26a has a defined maximum diameter 90a. The drill tip 26a has a defined maximum diameter 90a of at least 6 mm, in particular within a tolerance of a maximum of 0.1 mm. The drill tip 26a has a defined maximum diameter 90a of a maximum of 8 mm, in particular within a tolerance of a maximum of 0.1 mm. A ratio of the threaded length of the drill tip 26a to the maximum diameter 90a of the drill tip 26a is greater than 2.1, in particular rounded to two decimal places. A ratio of the thread length of the drill tip 26a to the maximum diameter 90a of the drill tip 26a is less than 2.35, in particular rounded to two decimal places. A smallest ratio of the maximum diameter 90a of the drill tip 26a to the diameter 88a of the shank body 52a is greater than 0.50, in particular more than 0.60, in particular more than 0.66, in particular rounded to two decimal places.

The smallest length ratio of a maximum length of the drill tip 26a along the rotation axis 16a to a maximum length of the wood-drilling device 10a, in particular the drilling unit 34a, along the rotation axis 16a is at least 0.075. The wood-drilling device 10a, in particular the drilling unit 34a, has a defined maximum length of a maximum of 156 mm along the rotation axis 16a, in particular with a tolerance of 3 mm. The smallest length ratio of a maximum length of the drill tip 26a along the rotation axis 16a to a maximum length of the wood-drilling device 10a, in particular the drilling unit 34a, along the rotation axis 16a is a maximum of 0.117, in particular rounded to three decimal places.

The drill tip 26a has a thread pitch of a maximum of 1.6 mm. The drill tip 26a has a length of at least 12 mm. The drill tip 26a has a length of a maximum of 20 mm. The drill tip 26a has a thread depth of at least 1.0 mm or 1.1 mm. The drill tip 26a has a threading angle of at least 40°. The drill tip 26a, in particular the thread 48a of the drill tip 26a, has a threading angle of 50°.

A ratio of the threaded pitch of the drill tip 26a to the threaded depth of the drill tip 26a amounts to a maximum of 1.25, in particular rounded to two decimal places.

A smallest length ratio of a maximum length of the drill tip 26a along the rotation axis 16a to a maximum length of the cutting body 18a along the rotation axis 16a is at least 0.25, in particular more than 0.5. In particular, the cutting body 18a has a short but solid body, in particular as compared to the drill tip 26a. The cutting body 18a has a maximum length of at least 25 mm along the rotation axis 16a, in particular with a maximum tolerance of 2 mm. The cutting body 18a has a maximum length of a maximum of 35 mm along the rotation axis 16a, in particular with a maximum tolerance of 2 mm. The drill tip 26a has a drill tip angle 182a of 17°, with a maximum tolerance of 3°.

The smallest length ratio of the maximum length of the drill tip 26a along the rotation axis 16a to the maximum length of the cutting body 18a along the rotation axis 16a is at least 0.3. The smallest ratio in length from the maximum length of the drill tip 26a along the rotation axis 16a to the maximum length of the cutting body 18a along the rotation axis 16a is a maximum of 0.8.

The first wood-drilling device 10a has a maximum thickness 176a of 16 mm, in particular with a maximum tolerance of 0.5 mm. The second wood-drilling device 12a has a defined maximum thickness 176a of 7.7 mm or 13 mm, in particular with a maximum tolerance of 0.5 mm.

The shank body 52a of the first wood-drilling device 10a has a uniform diameter 88a of 8.7 mm with a tolerance of 0.4 mm. The shank body 52a of the second wood-drilling device 12a has a uniform diameter 88a of 7.3 mm with a tolerance of 0.4 mm.

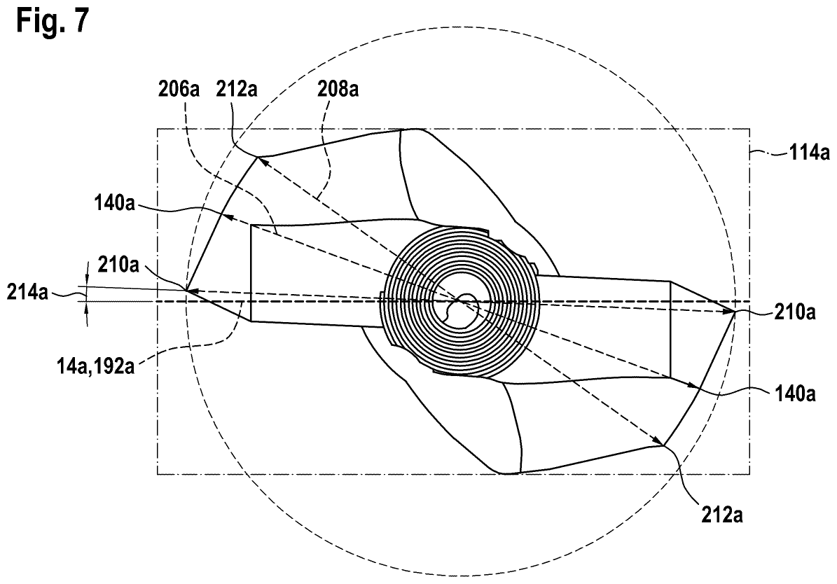

FIG. 7 shows the first wood-drilling device 10a in a top view along the rotation axis 16a on the drill tip 26a. FIG. 7 shows that the maximum extension 192a of the cutting body 18a perpendicular to the rotation axis 16a is an extension of the cutting body 18a from one of the radial outer edges 210a to the other radial outer edge 210a. An extension 206a of the cutting body 18a perpendicular to the rotation axis 16a from one of the radial edges 140a to the other radial edge 140a is shorter, in particular at least 5% of the maximum extension 192a of the cutting body 18a than the maximum extension 192a of the cutting body 18a perpendicular to the rotation axis 16a. An extension 208a of the cutting body 18a perpendicular to the rotation axis 16a from an outer edge that differs from the radial edges 140a and the radial outer edges 210a, in particular a second radial outer edge 212a, to another second radial outer edge 212a is shorter, in particular by at least 10% of the maximum extension 192a of the cutting body 18a, than the maximum extension 192a of the cutting body 18a perpendicular to the rotation axis 16a. The maximum extension 192a of the cutting body 18a perpendicular to the rotation axis 16a is aligned at an angle 214a of at least 2° to a greatest outer surface of the cuboid 114a, in particular as viewed along the rotation axis 16a (see FIG. 7). The radial outer edges 210a and the second radial outer edges 212a have a 4° angle to the rotation axis 16a, in particular with a tolerance of 2°.

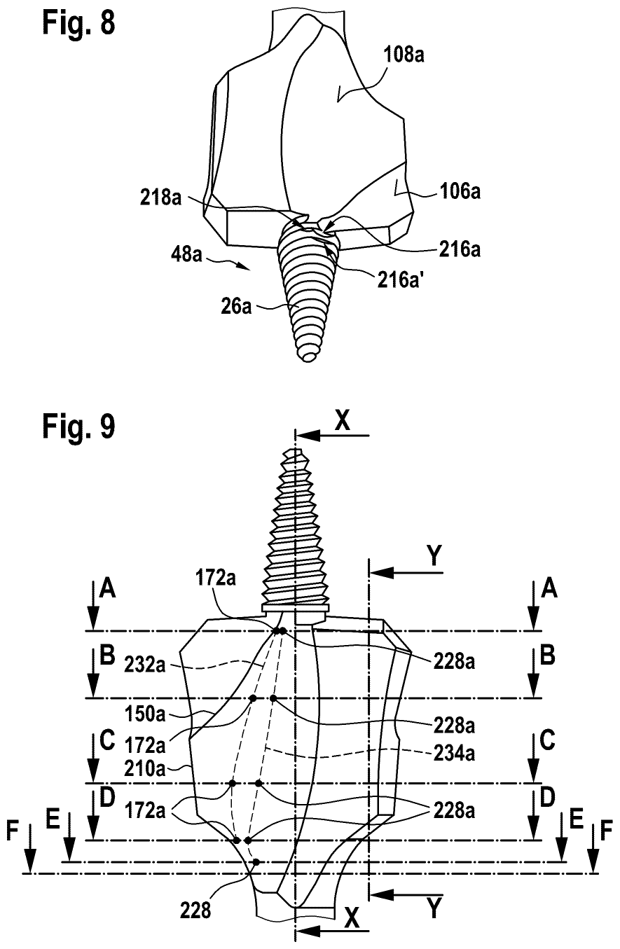

FIG. 8 shows that a bevel of the chipping surface 106a extends into the first two turns of the thread 48a of the drill bit 26a extending from the chipping surface 106a. The first two turns of the thread 48a of the drill tip 26a in each case have a chip recess 216a, 216′a, which in particular corresponds to the grind of the chipping surface 106a, due to which the drill tip 26a partially has a concave-round outer contour in a section perpendicular to the rotation axis 16a. The first turns of the thread 48a of the drill tip 26a have a chip recess 218a, which in particular corresponds to the grind of the chip conveying surface 108a 106, due to which the drill tip 26a partially has a concave outer contour in a section perpendicular to the rotation axis 16a.

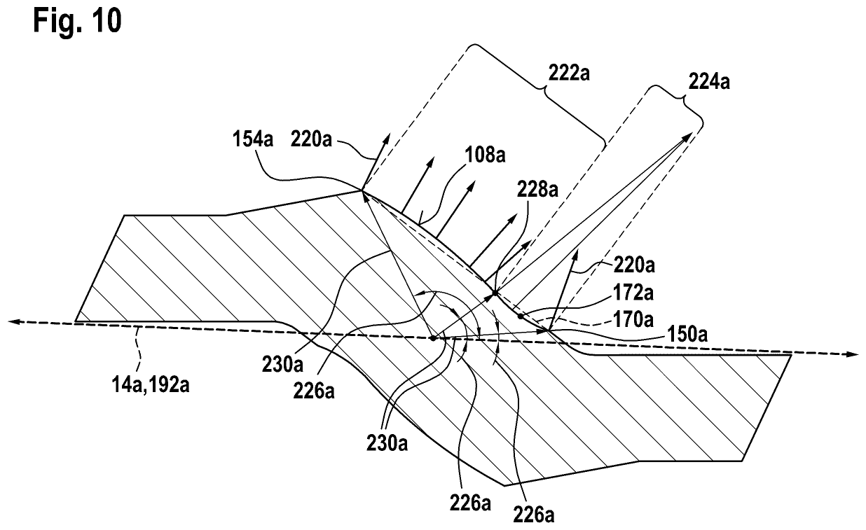

FIG. 9 shows an overview of sectional planes A-A, B-B, C-C, D-D, E-E, F-F through the cutting body 18a perpendicular to the rotation axis 16a, via a sectional plane X-X through the drilling unit 34a parallel to the rotation axis 16a and via a sectional plane Y-Y through the cutting body 18a parallel to the rotation axis 16a.

FIG. 10 shows the cutting body 18a in a sectional view along the A-A sectional plane.

In particular, the chip conveying surface 108a is shown in cross-section along the A-A sectional plane. As a guide, the maximum extension 192a of the cutting body 18a perpendicular to the rotation axis 16a is shown, which is not arranged in the cross-section along the A-A sectional plane.

Surface normals 220a are shown for a chip conveying surface 108a of the cutting body 18a. By way of example, for a better overview only the outer two surface normals 220a are provided with a reference number. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a.

In a concave partial surface 224a of the chip conveying surface 108a, adjacent surface normals 220a of the chip conveying surface 108a, which are, in particular, directed away from the cutting body 18a, intersect.

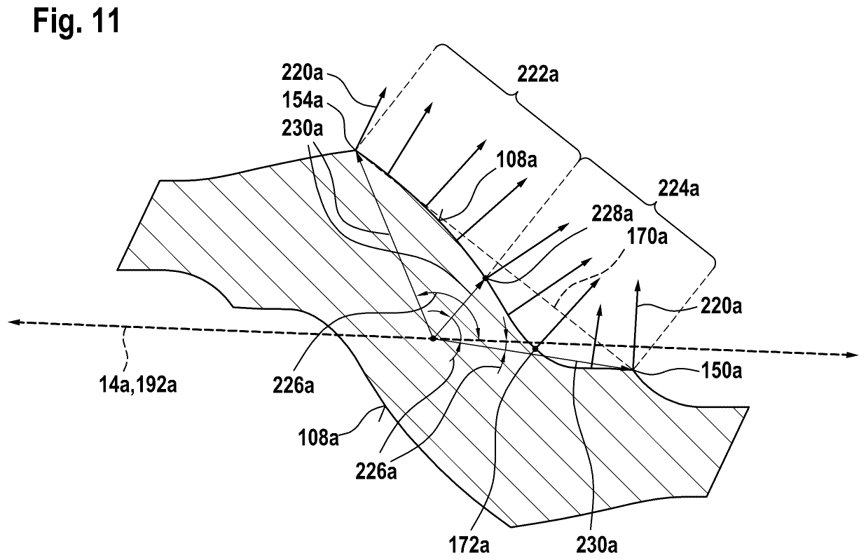

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of 35° to 112°, in the cross-section along the sectional plane A-A. In FIGS. 11 through 15, in each case three polar coordinates 230a are shown as examples.

The concave partial surface 224a is formed, in the polar coordinate system formed in particular by the maximum extension 192a of the cutting body 18a and an axis oriented perpendicular to the maximum extension 192a of the cutting body 18a and perpendicular to the rotation axis 16a, by points of the chip conveying surface 108a with an angle 226a in relation to the maximum extension 192a of the cutting body 18a of 8° to 35°, in the cross-section along the sectional plane A-A.

The chip conveying surface 108a, in the cross-section along the sectional plane A-A, has an inflection point 228a where the convex partial surface 222a transitions into the concave partial surface 224a. At the inflection point 228a, the surface normal 220a is part of both the concave partial surface 222a and the convex partial surface 224a. The inflection point 228a, in the polar coordinate system formed in particular by the maximum extension 192a of the cutting body 18a and an axis oriented perpendicular to the maximum extension 192a of the cutting body 18a and perpendicular to the rotation axis 16a, is formed by the point of the chip conveying surface 108a which has an angle 226a of 35° in relation to the maximum extension 192a of the cutting body 18a.

In the cross-section along the sectional plane A-A, the chip conveying surface 108a has the low point 172a, which is arranged farthest away from an imaginary connecting line 170a of the, in particular radial, end points of the chip conveying surface 108a (see FIG. 2 and FIG. 10).

FIG. 11 shows the cutting body 18a in a sectional view along the B-B sectional plane.

In particular, the chip conveying surface 108a is shown in a cross-section along the B-B sectional plane. As a guide, the maximum extension 192a of the cutting body 18a perpendicular to the rotation axis 16a, which is not arranged in this section along the B-B sectional plane, is shown.

Surface normals 220a are shown for a chip conveying surface 108a of the cutting body 18a. By way of example, for a better overview only the outer two surface normals 220a are provided with a reference number. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a.

In a concave partial surface 224a of the chip conveying surface 108a, adjacent surface normals 220a of the chip conveying surface 108a, which are, in particular, directed away from the cutting body 18a, intersect.

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of 50° to 125°, in the cross-section along the sectional plane B-B.

The concave partial surface 224a is formed, within the polar coordinate system formed in particular by the maximum extension 192a of the cutting body 18a and an axis oriented perpendicular to the maximum extension 192a of the cutting body 18a and perpendicular to the rotation axis 16a, by points of the chip conveying surface 108a with an angle 226a in relation to the maximum extension 192a of the cutting body 18a of 50° to −10 °, in the cross-section along the sectional plane B-B.

In the cross-section along the sectional plane B-B, the chip conveying surface 108a has an inflection point 228a at which the convex partial surface 222a transitions to the concave partial surface 224a. At the inflection point 228a, the surface normal 220a is part of both the concave partial surface 222a and the convex partial surface 224a. The inflection point 228a, within the polar coordinate system formed in particular by the maximum extension 192a of the cutting body 18a and an axis oriented perpendicular to the maximum extension 192a of the cutting body 18a and perpendicular to the rotation axis 16a, is formed by a point of the chip conveying surface 108a with an angle 226a of 50° in relation to the maximum extension 192a of the cutting body 18a.

In the cross-section along the sectional plane B-B, the chip conveying surface 108a has the low point 172a, which is arranged farthest away from an imaginary connecting line 170a of the, in particular radial, end points of the chip conveying surface 108a (see FIG. 2 and FIG. 11).

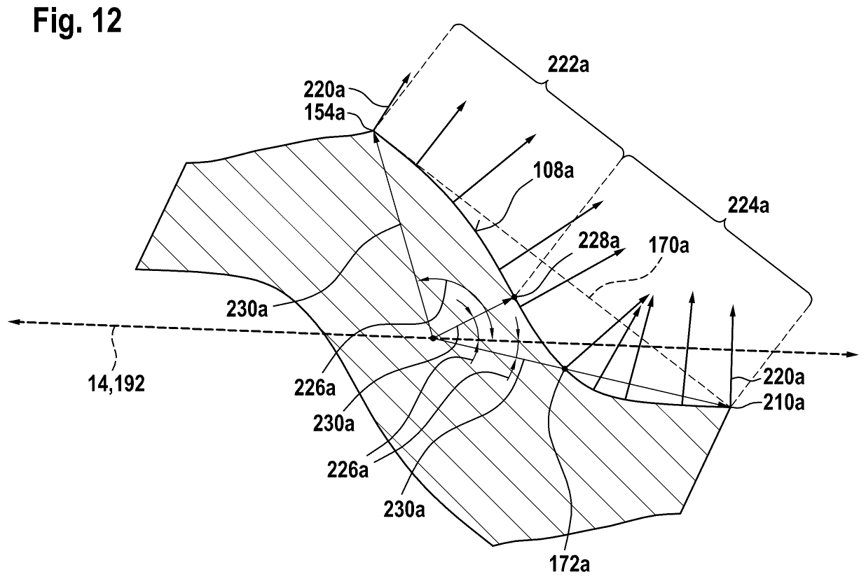

FIG. 12 shows the cutting body 18a in a sectional view along the C-C sectional plane.

In particular, the chip conveying surface 108a is shown in a cross-section along the C-C sectional plane. As a guide, the maximum extension 192a of the cutting body 18a perpendicular to the rotation axis 16a is shown, which is not arranged in this section along the C-C sectional plane.

Surface normals 220a are shown for a chip conveying surface 108a of the cutting body 18a. By way of example, for a better overview only the outer two surface normals 220a are provided with a reference number. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a.

In a concave partial surface 224a of the chip conveying surface 108a, adjacent surface normals 220a of the chip conveying surface 108a, which are, in particular, directed away from the cutting body 18a, intersect.

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of 30° to 111°, in the cross-section along the sectional plane C-C.

The concave partial surface 224a is formed, within the polar coordinate system formed in particular by the maximum extension 192a of the cutting body 18a and an axis oriented perpendicular to the maximum extension 192a of the cutting body 18a and perpendicular to the rotation axis 16a, by points of the chip conveying surface 108a, which have an angle 226a, which is intermediate to the maximum extension 192a of the cutting body 18a of 30° to −17 °, in the cross-section along the sectional plane C-C.

The chip conveying surface 108a has an inflection point 228a in the cross-section along the sectional plane C-C, at which the convex partial surface 222a transitions into the concave partial surface 224a. At the inflection point 228a, the surface normal 220a is part of both the concave partial surface 222a and the convex partial surface 224a. The point of inflection 228a, within the polar coordinate system formed in particular by the maximum extension 192a of the cutting body 18a and an axis oriented perpendicular to the maximum extension 192a of the cutting body 18a and perpendicular to the rotation axis 16a, is formed by a point of the chip conveying surface 108a with an angle 226a of 30° in relation to the maximum extension 192a of the cutting body 18a.

In the cross-section along the sectional plane C-C, the chip conveying surface 108a has the low point 172a, which is arranged farthest away from an imaginary connecting line 170a of the, in particular radial, end points of the chip conveying surface 108a (see FIG. 2 and FIG. 12).

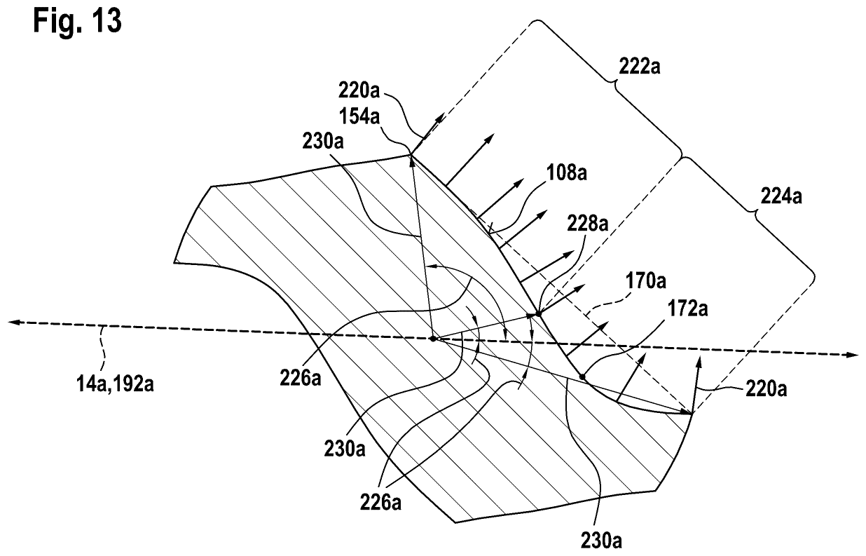

FIG. 13 shows the cutting body 18a in a sectional view along the D-D sectional plane.

In particular, the chip conveying surface 108a is shown in a cross-section along the D-D sectional plane. As a guide, the maximum extension 192a of the cutting body 18a perpendicular to the rotation axis 16a, which is not arranged in the cross-section along the D-D sectional plane, is shown.

Surface normals 220a are shown for a chip conveying surface 108a of the cutting body 18a. By way of example, for a better overview only the outer two surface normals 220a are provided with a reference figure. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a.

In a concave partial surface 224a of the chip conveying surface 108a, adjacent surface normals 220a of the chip conveying surface 108a, which are, in particular, directed away from the cutting body 18a, intersect.

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of 15° to 103°, in the cross-section along the sectional plane D-D.

The concave partial surface 224a is formed, in the polar coordinate system formed in particular by the maximum extension 192a of the cutting body 18a and an axis oriented perpendicular to the maximum extension 192a of the cutting body 18a and perpendicular to the rotation axis 16a, by points of the chip conveying surface 108a with an angle 226a in relation to the maximum extension 192a of the cutting body 18a of 15° to −19 °, in the cross-section along the sectional plane D-D.

In the cross-section along the sectional plane D-D, the chip conveying surface 108a has an inflection point 228a at which the convex partial surface 222a transitions to the concave partial surface 224a. At the inflection point 228a, the surface normal 220a is part of both the concave partial surface 222a and the convex partial surface 224a. The point of inflection 228a, within the polar coordinate system formed in particular by the maximum extension 192a of the cutting body 18a and an axis oriented perpendicular to the maximum extension 192a of the cutting body 18a and perpendicular to the rotation axis 16a, is formed by a point of the chip conveying surface 108a with an angle 226a of 15° in relation to the maximum extension 192a of the cutting body 18a.

In the cross-section along the sectional plane D-D, the chip conveying surface 108a has the low point 172a, which is arranged farthest away from an imaginary connecting line 170a of the, in particular radial, end points of the chip conveying surface 108a (see FIG. 2 and FIG. 13).

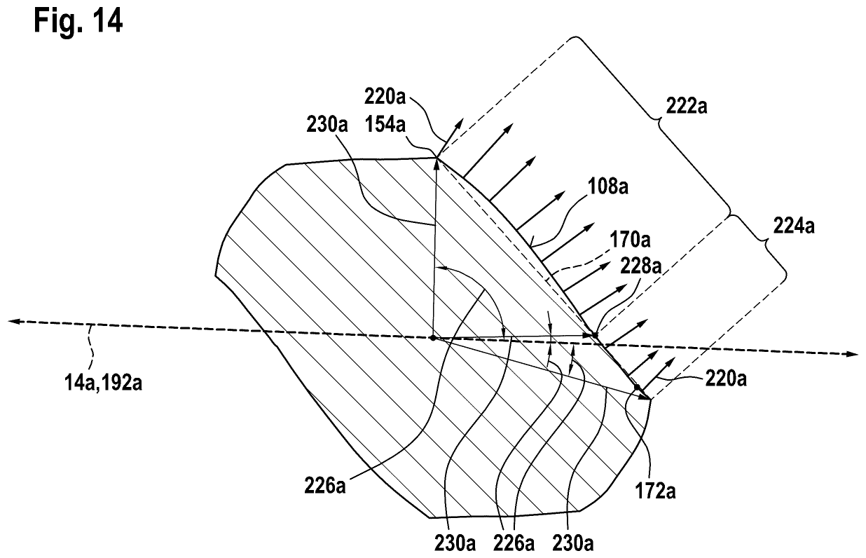

FIG. 14 shows the cutting body 18a in a sectional view along the E-E sectional plane.

In particular, the chip conveying surface 108a is shown in a cross-section along the E-E sectional plane. As a guide, the maximum extension 192a of the cutting body 18a perpendicular to the rotation axis 16a, which is not arranged in the cross-section along the E-E sectional plane, is shown.

Surface normals 220a are shown for a chip conveying surface 108a of the cutting body 18a. By way of example, for a better overview only the outer two surface normals 220a are provided with a reference figure. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a.

In a concave partial surface 224a of the chip conveying surface 108a, adjacent surface normals 220a of the chip conveying surface 108a, which are, in particular, directed away from the cutting body 18a, intersect.

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of 1° to 87°, in the cross-section along the sectional plane E-E.

The concave partial surface 224a is formed, within the polar coordinate system formed in particular by the maximum extension 192a of the cutting body 18a and an axis oriented perpendicular to the maximum extension 192a of the cutting body 18a and perpendicular to the rotation axis 16a, by points of the chip conveying surface 108a with an angle 226a in relation to the maximum extension 192a of the cutting body 18a of 1° to −14°, in the cross-section along the sectional plane E-E.

The chip conveying surface 108a has an inflection point 228a in the cross-section along the sectional plane E-E, at which the convex partial surface 222a transitions to the concave partial surface 224a. At the inflection point 228a, the surface normal 220a is part of both the concave partial surface 222a and the convex partial surface 224a. The point of inflection 228a, within the polar coordinate system formed in particular by the maximum extension 192a of the cutting body 18a and an axis oriented perpendicular to the maximum extension 192a of the cutting body 18a and perpendicular to the rotation axis 16a, is formed by a point of the chip conveying surface 108a with an angle 226a of 1° in relation to the maximum extension 192a of the cutting body 18a.

In the cross-section along the sectional plane E-E, the chip conveying surface 108a has the low point 172a, which is arranged farthest away from an imaginary connecting line 170a of the, in particular radial, end points of the chip conveying surface 108a (see FIG. 2 and FIG. 14).

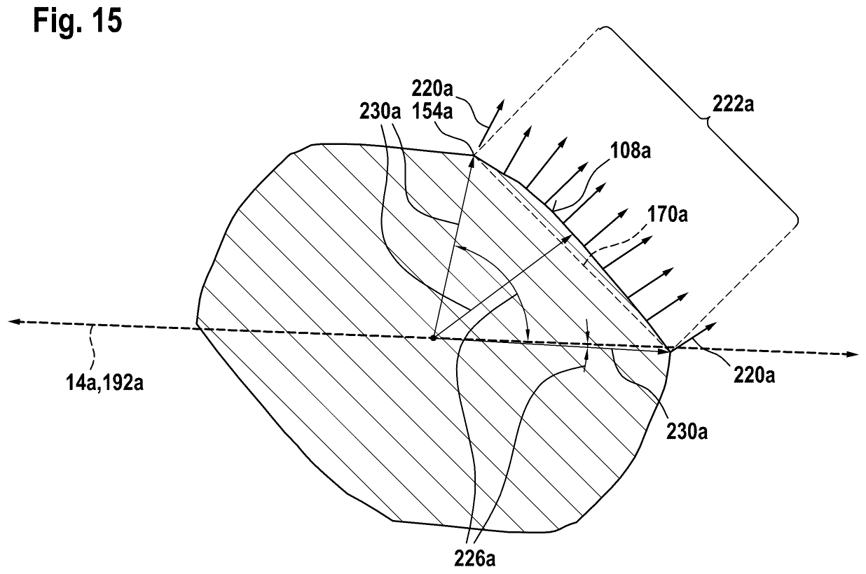

FIG. 15 shows the cutting body 18a in a sectional view along the F-F sectional plane.

In particular, the chip conveying surface 108a is shown in cross-section along the F-F sectional plane. As a guide, the maximum extension 192a of the cutting body 18a perpendicular to the rotation axis 16a is shown, which is not arranged in this section along the F-F sectional plane.

Surface normals 220a are shown for a chip conveying surface 108a of the cutting body 18a. By way of example, for a better overview only the outer two surface normals 220a are provided with a reference number. In a convex partial surface 222a of the chip conveying surface 108a, adjacent surface normals 220a of the chip conveying surface 108a are aligned with each other away from the cutting body 18a and free of intersections. In the convex partial surface 222a of the chip conveying surface 108a, all surface normals 220a are directed to a fanning angle, in particular a space angle, in particular away from the cutting body 18a. The chip conveying surface 108a is completely formed by the convex partial surface 222a in the cross-section along the sectional plane F-F.

In a polar coordinate system formed by the maximum extent 192a of the cutting body 18a and an axis oriented perpendicular to the maximum extent 192a of the cutting body 18a and perpendicular to the rotation axis 16a, the convex partial surface 222a is formed by points of the chip conveying surface 108a with an angle 226a in relation to the maximum extent 192a of the cutting body 18a of −5° to 72°, in the cross-section along the sectional plane F-F.

In FIG. 9, the low points 172a of the chip conveying surface 108a are schematically identified in each of the cross-sections of FIGS. 10 to 14 and connected to an imaginary low point line 232a.

The low point line 232a takes a curved path as viewed along the rotation axis 16a. The low points 172a of the chip conveying surface 108a are arranged at an end of the cutting body 18a that faces the drill tip 26a closer to an edge, in particular the boundary edge 150a or the radial outer edge 210a, of the chip conveying surface 108a that is radially distant from the rotation axis 16a than in the middle region of the maximum extension 152a of the cutting body 18a along the rotation axis 16a, in particular in the middle 50% of the cutting body 18a as measured by volume along the rotation axis 16a, wherein the proximity is, in particular, measured as a percentage in relation to the total extension of the chip conveying surface 108a perpendicular to the rotation axis 16a.

The low points 172a of the chip conveying surface 108a are arranged at an end of the cutting body 18a that faces the drill shank 30a closer to an edge, in particular the boundary edge 150a or the radial outer edge 210a, of the chip conveying surface 108a that is radially distant from the rotation axis 16a than in the middle region of the maximum extension 152a of the cutting body 18a along the rotation axis 16a, in particular in the middle 50% of the cutting body 18a as measured by volume along the rotation axis 16a, wherein the proximity is, in particular, measured as a percentage in relation to the total extension of the chip conveying surface 108a perpendicular to the rotation axis 16a.

In FIG. 9, the inflection points 228a of the chip conveying surface 108a from each of the cross-sections of FIGS. 10 through 14 are schematically identified, and connected to an imaginary inflection point line 234a extending along the rotation axis 16a across the chip conveying surface 108a.

The inflection point line 234a takes a curved path as viewed along the rotation axis 16a. The inflection points 228a of the chip conveying surface 108a are arranged at an end of the cutting body 18a that faces the drill tip 26a closer to an edge, in particular the boundary edge 150a or radial outer edge 210a, of the chip conveying surface 108a, radially distant from the rotation axis 16a, than in the middle region of the maximum extension 152a of the cutting body 18a along the rotation axis 16a, in particular in the middle 50% of the cutting body 18a measured by volume along the rotation axis 16a, wherein the proximity is, in particular, measured as a percentage in relation to the total extension of the chip conveying surface 108a perpendicular to the rotation axis 16a.

The inflection points 228a of the chip conveying surface 108a are arranged at an end of the cutting body 18a that faces the drill shank 30a closer to an edge, in particular the boundary edge 150a or the radial outer edge 210a, of the chip conveying surface 108a, radially distant from the rotation axis 16a, than in the middle region of the maximum extension 152a of the cutting body 18a along the rotation axis 16a, in particular in the middle 50% of the cutting body 18a as measured by volume along the rotation axis 16a, wherein the proximity is, in particular, measured as a percentage in relation to the total extension of the chip conveying surface 108a perpendicular to the rotation axis 16a.

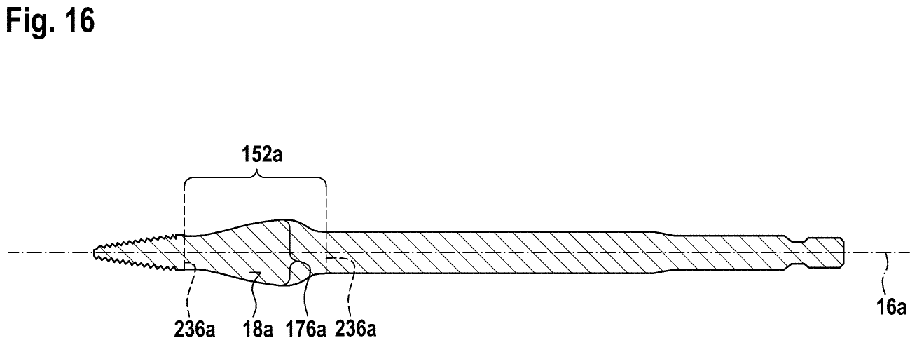

FIG. 16 shows the cutting body 18a in a sectional view along the X-X sectional plane (see FIG. 9).

In particular, the cutting body 18a is shown in a cross-section along the X-X sectional plane. As a guide, the rotation axis 16a is shown in FIG. 16. Additionally, the cutting body 18a is labeled with two imaginary boundary lines 236a.

The maximum thickness 176a of the cutting body 18a is spaced apart from a center of the cutting body 18a along the rotation axis 16a. The maximum thickness 176a of the cutting body 18a is arranged in a half that faces the drill shank 30a, in particular as measured by distance along the rotation axis 16a, of the cutting body 18a. The maximum thickness 176a of the cutting body 18a is arranged in a third that faces the drill shank 30a, in particular as measured by distance along the rotation axis 16a, of the cutting body 18a.

FIG. 17 shows the cutting body 18a in a sectional view along the Y-Y sectional plane (see FIG. 9).

In particular, the cutting body 18a is shown in a cross-section along the Y-Y sectional plane. As a guide, the rotation axis 16a is shown in FIG. 16.

The cutting body 18a, in particular the cutting wings 66a, 68a, has a shank side edge 238a on a side that faces the drill shank 30a, which is adjacent to the radial outer surfaces 142a, 144a.

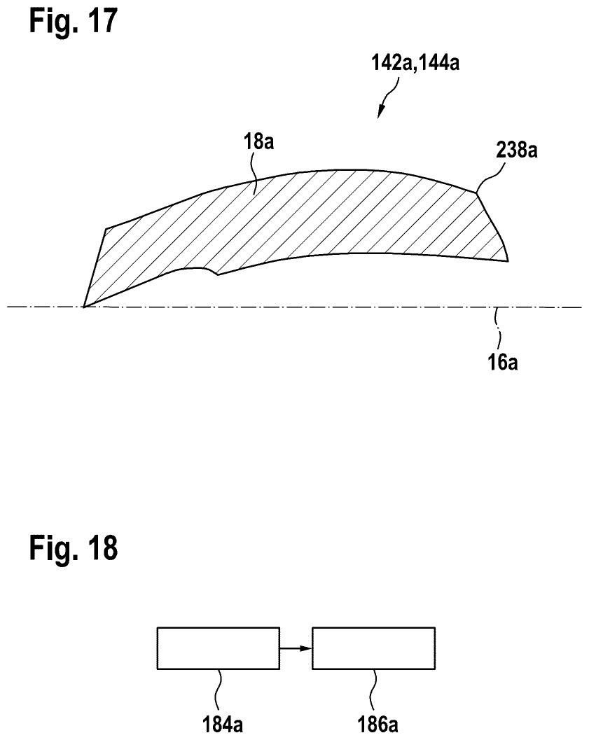

FIG. 18 schematically shows a method of producing the wood-drilling devices 10a, 12a.

In a method step, in particular, a forging step 184a, the drilling unit 34a, 36a, in particular the drill shank 30a, 32a, the cutting body 18a, 24a and the drill tip 26a, 28a, are forged from a drill head blank, wherein a maximum diameter 14a, 20a of the cutting body 18a, in particular as measured perpendicular to a longitudinal axis of the drill shank 30a, 32a, is at least one and a half times as large as the original diameter of the drill head blank, in particular as measured perpendicular to a longitudinal axis of the drill head blank, in particular prior to the forging process.

Preferably, in a process step, in particular the forging step 184a, the drilling unit 34a, 36a is forged from the drill head blank with a maximum extension 192a perpendicular to the rotation axis 16a, wherein the original diameter of the drill head blank, in particular as measured perpendicular to a longitudinal axis of the drill head blank, in particular before the forging process, is no more than two thirds as large as the maximum extension 192a of the drilling unit 34a, 36a perpendicular to the rotation axis 16a and/or to the longitudinal axis of the drill unit 34a, 36a.

Preferably, in a method step, in particular a grinding step 186a, the radial outer surfaces 142a, 144a are ground to the cutting body 18a.

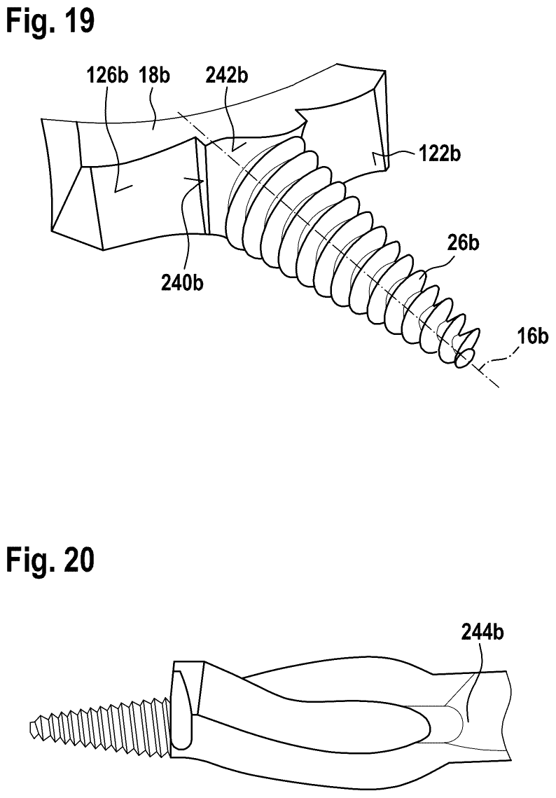

FIGS. 19 and 20 show a further embodiment example of the disclosure. The following descriptions and the drawings are essentially limited to the differences between the embodiment examples, wherein reference can be made in relation to identically designated components, in particular in relation to components with the same reference numbers, in principle also to the drawings and/or the description of the other embodiment examples, in particular FIGS. 1 to 18. In order to distinguish the embodiment examples, the letter a is appended to the reference numbers of the embodiment example in FIGS. 1 to 18. In the embodiment examples of FIGS. 19 and 20, the letter a is replaced by the letter b.

FIG. 19 shows a base side 70b of the cutting body 18b. The cutting surfaces 116b, 118b are spaced apart from the rotation axis 16b by at least 120% of the maximum thickness, in particular the diameter 90b, of a drill tip 26b, in particular as measured perpendicular to the rotation axis 16b. The cutting surfaces 116b, 118b are arranged spaced apart from the drill tip 26b.

The cutting partial surfaces 122b, 126b that are arranged facing the drill tip 26b are in each case adjacent to a tip surface 240b in the direction of the rotation axis 16b, which is aligned parallel to the rotation axis 16b up to deviations of no more than 10°. Spacer surfaces 242b are arranged between the drill tip 26b and the cutting partial surfaces 122b, 126b, which are oriented parallel to the cutting partial surfaces 122b, 126b apart from deviations of a maximum of 20°. The spacer surfaces 242b are arranged along the rotation axis 16b at an offset from the cutting surfaces 116b, 118b.

FIG. 20 shows the cutting body 18b. In this example, the cutting body 18b, in particular two cutting wings 66b, 68b, has a rounded drill shank side 244b, which is arranged so that it faces a drill shank 30b.

1. A wood drilling device for drilling a wood material, comprising:
at least one drill shank configured to be clamped on a machine tool,
at least one drill tip having a thread, and
at least one cutting body (i) configured to cut the wood material, (ii) and defining a rotation axis,
wherein the at least one cutting body has at least one cutting wing,
wherein the at least one cutting wing has a cutting surface which is arranged on a base side facing the drill tip,
wherein the base side is arranged in relation to an imaginary cylinder about the rotation axis, and
wherein the cutting surface is formed by at least two cutting partial surfaces bordering one another, angled from a drill plane perpendicular to the rotation axis in the direction of the drill shank, which are angled at an angle to one another and which in each case has an angle other than 0° to the rotation axis.

2. A wood-drilling device according to claim 1, wherein the at least two cutting partial surfaces are formed as flat surfaces.

3. A wood-drilling device according to claim 1, wherein one cutting partial surface of the at least two cutting partial surfaces arranged facing the drill tip has an angle of 5° to the drill plane except for deviations of no more than 2°.

4. A wood-drilling device according to claim 1, wherein a cutting partial surface of the at least two cutting partial surfaces that are arranged facing away from the drilling tip has an angle of 45° to the drill plane except for deviations of no more than 5°.

5. A wood-drilling device according to claim 1, wherein a cutting partial surface of the at least two cutting partial surfaces that are arranged facing the drill tip has a maximum extension perpendicular to the rotation axis which extends no more than twice as far as a maximum extension perpendicular to the rotation axis of a cutting partial surface of the at least two cutting partial surfaces that are arranged facing away from the drill tip.

6. A wood-drilling device according to claim 1, wherein a cutting partial surface of the at least two cutting partial surfaces that are arranged facing the drill tip has a maximum extension perpendicular to the rotation axis which extends at least as far as a maximum extension perpendicular to the rotation axis of a cutting partial surface of the at least two cutting partial surfaces that are arranged facing away from the drill tip.

7. A wood-drilling device according to claim 1, wherein the at least one cutting wing has at least two radial outer surfaces which are angled with respect to one another over a radial edge, which extends parallel to the rotation axis up to deviations of no more than 15°, and which are arranged at a free end of the respective cutting wing radially facing away at a maximum distance from the rotation axis.

8. A wood-drilling device according to claim 1, wherein the wood-drilling device is configured for impact drilling a wood material containing metal fragments.

9. A wood-drilling device according to claim 8, wherein the cutting body, on at least one outer side, which is defined in relation to an imaginary cylinder about the rotation axis, has (i) a chipping surface for chip removal from the wood material and/or the metal fragments, and (ii) a chip conveying surface which is adjacent to the chipping surface and which is designed to have a partly concave and partly convex curvature.

10. A wood-drilling device according to claim 1, wherein a ratio of the threaded length of the drill tip to the maximum diameter of the drill tip is greater than 2.0.

11. A wood-drilling device according to claim 1, wherein:
the at least one drill shank, the at least one drill tip and the at least one cutting body form a drilling unit which is formed from a material composition,
the at least one drilling unit has at least two distinguishable hardness ranges as measured according to Rockwell,
the at least one drill shank has a shank body with a uniform diameter and a tool connecting body which are directly connected to one another,
the shank body has a hardness limit which divides the shank body into two hardness regions with different hardness levels, and
the hardness boundary is arranged at a distance from the tool connecting body.

12. A wood-drilling device according to claim 1, wherein the at least one cutting wing includes at least two cutting wings arranged symmetrically in relation to one another in relation to the rotation axis of the cutting body.

13. A wood-drilling system, comprising:
an electric machine tool; and
at least one wood-drilling device according to claim 1.

14. A method of producing a wood-drilling device according to claim 1.

15. The method of claim 14, wherein:
in at least one method step, the at least one drilling unit is forged from a drill head blank, and
a maximum diameter of the cutting body, perpendicular to a longitudinal axis of the drill shank, is at least one and a half times the original diameter of the drill head blank as measured perpendicular to a longitudinal axis of the drill head blank, prior to the forging process.
